(19) United States
(12) Patent Application Publication
(10) Pub. No.: US 2025/0128404 A1
(43) Pub. Date: Apr. 24, 2025

(54) ROBOT

(71) Applicant: YAMAHA HATSUDOKI KABUSHIKI KAISHA, Iwata-shi, Shizuoka-ken (JP)

(72) Inventor: Toshifumi MANOME, Iwata-shi (JP)

(73) Assignee: YAMAHA HATSUDOKI KABUSHIKI KAISHA, Iwata-shi, Shizuoka-ken (JP)

(21) Appl. No.: 18/692,956

(22) PCT Filed: Oct. 14, 2021
(86) PCT No.: PCT/JP2021/038047

§ 371 Date: Mar. 18, 2024

(51) Int. Cl. B25J 9/10; B25J 17/00; B25J 18/04; B25J 19/00

(52) U.S. Cl. CPC B25J 9/102; B25J 17/00; B25J 18/04; B25J 19/0004; B25J 19/0025

(57) ABSTRACT

A robot according includes a carrier of an eccentric oscillating speed reducer that is attached to a base to be prevented from rotating in response to rotation of a first arm rotated by an output part of the eccentric oscillating speed reducer in a case in which the eccentric oscillating speed reducer is provided to a first joint, and is attached to the first arm to be prevented from rotating in response to rotation of a second arm rotated by the output part of the eccentric oscillating speed reducer in a case in which the eccentric oscillating speed reducer is provided to a second joint. An electric motor is attached to the carrier.

### CROSS-REFERENCE TO RELATED APPLICATION

This application is a National Stage of International Patent Application No. PCT/JP2021/038047, filed Oct. 14, 2021, the entire content of which is incorporated herein by reference.

### BACKGROUND

### Technical Field

The present disclosure relates to a robot, in particular, to a robot including an electric motor.

### Background Art

Robots including electric motors are known in the art. Such a robot is disclosed in Japanese Patent Laid-Open Publication No. JP 2020-116716, for example.

The above Japanese Patent Laid-Open Publication No. JP 2020-116716 discloses a robot including an electric motor, and first to sixth arms. Here, a joint structure between the second arm and the third arm in the first to sixth arms in the robot includes the second arm, the third arm, a speed reducer, a casing, and the electric motor. The third arm is rotatably attached to the second arm.

The speed reducer in the joint structure of the robot in the above Japanese Patent Laid-Open Publication No. JP 2020-116716 is configured to be driven by the electric motor so as to rotate the third arm relative to the second arm. The speed reducer includes an input gear, a crankshaft and a speed reducer output shaft. The input gear is connected to the electric motor. The crankshaft is rotated by a driving force of the electric motor transmitted through the input gear. The speed reducer output shaft is rotated by the driving force of the electric motor by decelerating and transmitting the rotation of the crankshaft. The casing is configured to rotate together with the speed reducer output shaft. The casing is connected to the third arm. Accordingly, the third arm can be rotated by the rotation of the casing. The electric motor is attached to the casing.

### SUMMARY

However, in the robot disclosed in the above Japanese Patent Laid-Open Publication No. JP 2020-116716, because the electric motor is attached to the casing, the electric motor rotates together with the casing. Accordingly, in the robot described in the above Japanese Patent Laid-Open Publication No. JP 2020-116716, wiring connected to the electric motor will repeatedly move in response to the rotation of the electric motor, and as a result special wiring such as a movable harness is necessarily provided for such repeated movements. For this reason, it is desired to use general-purpose wiring, which is more widely used, in the robot described in the above Japanese Patent Laid-Open Publication No. JP 2020-116716 to simplify a configuration of the robot.

The present disclosure provides a robot capable of using general-purpose wiring, which is more widely used, to simplify a configuration of the robot.

A robot according to one aspect of the present disclosure includes a base: a first arm relatively rotatably attached to the base: a second arm relatively rotatably attached to the first arm: a first joint serving as a part connecting the first arm and the base to each other; a second joint serving as a part connecting the first arm and the second arm to each other: an electric motor; and an eccentric oscillating speed reducer including an input part configured to be rotated by a driving force of the electric motor, an eccentric rotating part configured to receive rotation of the input part that is decelerated and transmitted to the eccentric rotating part, an output part configured to receive rotation of the eccentric rotating part that is decelerated and transmitted to the output part, and a carrier arranged inside the output part. The carrier of the eccentric oscillating speed reducer is attached to the base to be prevented from rotating in response to rotation of the first arm rotated by the output part of the eccentric oscillating speed reducer in a case in which the eccentric oscillating speed reducer is provided to the first joint, and is attached to the first arm to be prevented from rotating in response to rotation of the second arm rotated by the output part of the eccentric oscillating speed reducer in a case in which the eccentric oscillating speed reducer is provided to the second joint; and the electric motor is attached to the carrier.

In the robot according to the one aspect of the present disclosure, as discussed above, the carrier of the eccentric oscillating speed reducer is, in a case in which the eccentric oscillating speed reducer is provided to the first joint, attached to the base to be prevented from rotating in response to rotation of the first arm rotated by the output part of the eccentric oscillating speed reducer in a case in which the eccentric oscillating speed reducer is provided to the first joint, and is attached to the first arm to be prevented from rotating in response to rotation of the second arm rotated by the output part of the eccentric oscillating speed reducer in a case in which the eccentric oscillating speed reducer is provided to the second joint. In addition, the electric motor is attached to the carrier. According to this configuration, because the electric motor does not rotate (does not pivot) together with the first arm or the second arm, special wiring such as a movable harness for connection of the electric motor is not necessarily provided for repeated movements of wires connected to the first electric motor. As a result, it is possible to simplify a configuration of the robot by using general-purpose wiring, which is more widely used. Also, because the electric motor does not rotate (does not pivot) together with the first arm or the second arm, a wiring route of a wire set that is connected to the electric motor and extends from the electric motor into the base can be a fixed route. For this reason, it is possible to reduce increase of wiring space required to place the wire set (to make the wiring route of the wire set fixed) as compared with a case in which the electric motor rotates together with the first arm or the second arm. Because increase of wiring space can be reduced, it is possible to easily place the wire set connected to the electric motor in the base or the first arm.

In the robot according to the aforementioned one aspect, it is preferable that the robot further includes an electric-motor holder attached to the carrier with the electric-motor holder being holding the electric motor. According to this configuration, even in a case in which space is not enough to directly attach the electric motor to the carrier, because the electric motor can be attached to the carrier by using the electric-motor holder, it is possible to securely attach the electric motor to the carrier.

In this configuration, it is preferable that the carrier is attached to the base to be prevented from rotating in response to rotation of the first arm; and that the electric motor is arranged in exterior space of the base and fixed to the carrier with the electric-motor holder. According to this configuration, because the electric motor can be cooled by outside air, it is possible to efficiently cool the electric motor as compared with a configuration in which the electric motor is arranged inside the base.

In the aforementioned robot that includes the electric motor arranged in exterior space of the base, it is preferable that the robot further includes an oil seal arranged between the electric-motor holder and the first arm. According to this configuration, even in a case in which the first arm is rotated by rotating the output part while the electric motor arranged in the exterior space of the base is attached to the carrier, it is possible to prevent leakage of grease used in the eccentric oscillating speed reducer through a gap between the carrier and the output part to the outside.

In the aforementioned robot that includes the electric motor arranged in exterior space of the base, it is preferable that one electric motor is provided as the electric motor; that the carrier includes a first carrier part arranged on a side opposite to the base side in an extension direction of a rotation axis of the eccentric rotating part, and a second carrier part connected to the first carrier part and arranged on the base side in the extension direction of the rotation axis of the eccentric rotating part: that the second carrier part is attached to the base; and that the electric motor is attached to the first carrier part. According to this configuration, because the second carrier part is attached to the base so that the second carrier part does not rotate together with the first arm, the first carrier part connected to the second carrier part does not rotate together with the first arm. Consequently, it is possible to easily attach the electric motor configured not to rotate together with the first arm to the carrier.

In the aforementioned robot that includes the electric motor attached to the first carrier part, it is preferable that the electric motor is arranged at an offset position offset from a center of the first carrier part in a radial direction orthogonal to the extension direction of the rotation axis of the eccentric rotating part. According to this configuration, because the electric motor does not cover a central part of the first carrier part in the radial direction orthogonal to the extension direction of the rotation axis of the eccentric rotating part, the central part of the first carrier part can be used for a particular use such as passage of a wire set.

In the aforementioned robot that includes the electric motor arranged at an offset position offset from a center of the first carrier part, it is preferable that the eccentric oscillating speed reducer includes a hollow transmission shaft having a through hole extending in the extension direction of the rotation axis of the eccentric rotating part and connected to the input part to transmit the driving force from the electric motor to the eccentric rotating part; and that the robot further includes a wire set connected to the electric motor with the wire set passing through the through hole. According to this configuration, because the wire set can be accommodated in the first carrier part dissimilar to a configuration in which the wire set is placed outside the first carrier part, it is possible to reduce exposure of the wire set.

In the aforementioned robot that includes the hollow transmission shaft having a through hole, it is preferable that the base includes a base-side venting part configured to provide ventilation between interior space of the base and the exterior space of the base; and that the robot further includes a shaft cover covering the electric motor side of the through hole of the transmission shaft in the extension direction of the rotation axis of the eccentric rotating part and having a speed-reducer-side venting part configured to provide ventilation between the interior space of the base and the exterior space of the base through the through hole. According to this configuration, because air can flow through the base-side venting part, the through hole of the transmission shaft and the speed-reducer-side venting part of the shaft cover, it is possible to efficiently cool the eccentric oscillating speed reducer.

In the aforementioned robot that includes the electric-motor holder, it is preferable that the electric-motor holder includes a protruding fin formed an exterior surface of the electric-motor holder. According to this configuration, because the electric motor can be efficiently cooled by the protruding fin, it is possible to efficiently cool the electric motor held by the electric-motor holder.

In the aforementioned robot that includes the hollow transmission shaft having a through hole, it is preferable that the base includes a base-side venting part configured to provide ventilation between interior space of the base and the exterior space of the base; and that the robot further includes an electric-motor cover covering the electric motor and having an electric-motor side venting part configured to provide ventilation between the interior space of the base and the exterior space of the base through the through hole. According to this configuration, because dust resistance of the electric motor can be improved by the electric-motor cover covering the electric motor while air can flow from the base-side venting part to the electric-motor side venting part, it is possible to efficiently cool the electric motor in the electric-motor cover.

In the aforementioned robot that includes the electric-motor cover, it is preferable that the electric motor and the electric-motor cover are directly connected to each other, or are connected to each other with a heat conductor. According to this configuration, because transfer of heat from the electric motor to the electric-motor cover is enhanced, it is possible to efficiently cool the electric motor in the electric-motor cover.

In the aforementioned robot that includes the electric-motor holder, it is preferable that a plurality of electric motors are configured to rotate in synchronization with each other as the electric motor: that the eccentric rotating part includes a plurality of crankshafts; and that the plurality of crankshafts are configured to be rotated by driving forces of the plurality of electric motors. According to this configuration, it is possible to increase a driving force of the eccentric oscillating speed reducer as compared with a configuration in which the plurality of crankshafts are rotated by a single electric motor. As a result, it is possible to increase an available weight that can be rotated by the eccentric oscillating speed reducer.

In the aforementioned robot that includes the plurality of electric motors, it is preferable that the plurality of electric motors includes a first electric motor and a second electric motor: that the carrier includes a first carrier part arranged a side opposite to the base or first arm side in an extension direction of a rotation axis of the crankshaft, and a second carrier part connected to the first carrier part and arranged the base or first arm side in the extension direction of the rotation axis of the crankshaft: that the first electric motor is attached to at least one of the first carrier part and the second carrier part; and that the second electric motor is attached to at least one of the first carrier part and the second carrier part. According to this configuration, because the second carrier part is attached to the base or the first arm so that the second carrier part does not rotate together with the first arm or the second arm, the first carrier part connected to the second carrier part does not rotate together with the first arm or the second arm. Consequently, it is possible to easily attach the first electric motor and the second electric motor that do not rotate together with the first arm or the second arm to the carrier.

In the aforementioned robot that includes the first and second carrier parts, it is preferable that the second carrier part is attached to the base or the first arm; and that both the first electric motor and the second electric motor are attached to the second carrier part with the first electric motor and the second electric motor being arranged in interior space of the base or the first arm. According to this configuration, because both the first and second electric motors can be placed in the interior space of the base or the first arm without rotating together with the first arm or the second arm, it is possible to prevent interference between the first and second electric motors, and other components placed in the interior space of the base or the first arm.

In the aforementioned robot that includes the first and second carrier parts, it is preferable that the second carrier part is attached to the base or the first arm; and that both the first electric motor and the second electric motor are attached to the first carrier part with the first electric motor and the second electric motor being arranged in exterior space of the base or the first arm. According to this configuration, because the first electric motor and the second electric motor can be cooled by outside air, it is possible to efficiently cool the first electric motor and the second electric motor.

In the aforementioned robot that includes the first and second carrier parts, it is preferable that the second carrier part is attached to the base or the first arm: that the first electric motor is attached to the first carrier part; and that the second electric motor is attached to the second carrier part and to the base or the first arm with the second electric motor being arranged in interior space of the base or the first arm. According to this configuration, the first electric motor can be attached to the first carrier part without rotating together with the first arm or the second arm, and the second electric motor can be placed in the interior space of the base or the first arm without rotating together with the first arm or the second arm. Because both the first and second electric motors do not rotate together with the first or second arm, it is possible to prevent the first and second electric motors from rotating relative to each other. Because rotation speeds of the electric motors are not necessarily controlled in consideration of relative rotation between the first electric motor and the second electric motor that occurs due to rotation of the first arm or the second arm, it is possible to easily control the first electric motor and the second electric motor in synchronization with each other

In the aforementioned robot that includes the second electric motor arranged in the interior space of the base or the second arm, it is preferable that the input part includes a first input gear connected to the first electric motor, and a second input gear connected to the second electric motor; and that the eccentric oscillating speed reducer includes a plurality of spur gears configured to transmit a driving force of the first input gear and a driving force of the second input gear to the plurality of crankshafts. According to this configuration, because the plurality of spur gears can rotate with the plurality of spur gears being meshing with both the first and second input gears, rotation speeds of the first and second electric motors can be reduced by changing the number of teeth of the plurality of spur gears, the numbers of teeth of the first and second input gears so that the rotations can be decelerated and transmitted to the plurality of crankshafts.

In the aforementioned robot that includes the first and second input gears, it is preferable that the first input gear and the second input gear mesh with the plurality of spur gears that are common to the first input gear and the second input gear; and that the plurality of spur gears that are common to the first input gear and the second input gear are arranged on the base or first arm side of each of the plurality of crankshafts with the first input gear being meshing with the first carrier side of each of the plurality spur gears and the second input gear being meshing with the second carrier side of each of the plurality of spur gears. According to this configuration, because both the first input gear and the second input gear can be connected to the plurality of spur gears that are common to the first input gear and the second input gear, a load and friction of the eccentric oscillating speed reducer applied to the first electric motor can be substantially equal to a load and friction of the eccentric oscillating speed reducer applied to the second electric motor. Because the plurality of crankshafts can be rotated similarly to each other by controlling the first and second electric motors similarly to each other, it is possible to easily control the first and second electric motors in synchronization with each other.

In the aforementioned robot that includes the first and second input gears, it is preferable that the plurality of spur gears include a first spur gear arranged on a side of each of the plurality of crankshafts opposite to the base or first arm side and connected to the first input gear, and a second spur gear arranged on the base or the first arm side of each of the plurality of crankshafts and connected to the second input gear. According to this configuration, because the first spur gear can be arranged on a side closer to the first electric motor, it is possible to reduce an interval between the first input gear and the first electric motor. According to this configuration, because the second spur gear can be arranged on a side closer to the second electric motor, it is possible to reduce an interval between the second input gear and the second electric motor. Accordingly, because a mass of a shaft between the first input gear and the first electric motor can be reduced while a mass of a shaft between the second input gear and the second electric motor can be reduced, it is possible to prevent increase of load inertia (moment of load inertia) applied to the first and second electric motors.

In the aforementioned robot that includes the first and second spur gears, it is preferable that an interval between the first electric motor and the first input gear is substantially equal to an interval between the second electric motor and the second input gear in an extension direction of the crankshaft. According to this configuration, because a length of a shaft connecting the first electric motor to the first input gear can be equal to a length of a shaft connecting the second electric motor to the second input gear, a mass of the shaft connecting the first electric motor to the first input gear can be substantially equal to a mass of the shaft connecting the second electric motor to the second input gear. As a result, inertia (moment of inertia) generated when the first input gear is rotated can be substantially equal to inertia (moment of inertia) generated when the second input gear is rotated.

In the aforementioned robot that includes the first and second input gears, it is preferable that the eccentric oscillating speed reducer further includes an external gear part having external teeth that mesh with the output part and configured to decelerate and transmit the rotation of the crankshaft to the output part by oscillating in response to the rotation of the crankshaft with the external gear part being attached to the carrier to be able to oscillate; and that each of the plurality of spur gears is arranged between an end of the external gear part opposite to the base or first arm side and an end of the external gear part on the base or first arm side in the extension direction of the crankshaft. According to this configuration, because an interval between the first electric motor and the first input gear can be equal to an interval between the second electric motor and the second input gear, it is possible to reduce a difference between a mass of a shaft extending from the first electric motor to the first input gear and a mass of a shaft extending from the second electric motor to the second input gear. Because difference between inertia (moment of inertia) generated when the first input gear is rotated and inertia (moment of inertia) generated when the second input gear is rotated can be reduced, it is possible to easily control the first and second electric motors in synchronization with each other.

In the aforementioned robot that includes the first and second carrier parts, it is preferable that at least one of the first electric motor and the second electric motor is fixed to the second carrier part with the at least one of first electric motor and the second electric motor being arranged in the interior space of the base; and that the robot further includes an impeller attached to the first arm and configured to rotate together with the first arm so as to flow air from the interior space of the base to exterior space of the base. According to this configuration, because at least one of the first and second electric motors placed in the interior space of the base can be cooled by the impeller, it is possible to efficiently cool the at least one of the first and second electric motors placed in the interior space of the base.

In the aforementioned robot that includes the first and second carrier parts, it is preferable that at least one of the first electric motor and the second electric motor is fixed to the second carrier part with the at least one of first electric motor and the second electric motor being arranged in the interior space of the base; and that the robot further includes an electric fan attached to the base and configured to flow air from the interior space of the base to exterior space of the base. According to this configuration, because at least one of the first and second electric motors placed in the interior space of the base can be cooled by the electric fan, it is possible to efficiently cool the at least one of the first and second electric motors placed in the interior space of the base.

A robot according to a second aspect of the present disclosure includes a base: a first arm relatively rotatably attached to the base: a second arm relatively rotatably attached to the first arm; a first joint serving as a part connecting the first arm and the base to each other: a second joint serving as a part connecting the first arm and the second arm to each other: an electric motor; and an eccentric oscillating speed reducer including an input part configured to be rotated by a driving force of the electric motor, an eccentric rotating part configured to receive rotation of the input part that is decelerated and transmitted to the eccentric rotating part, an output part configured to receive rotation of the eccentric rotating part that is decelerated and transmitted to the output part, and a carrier arranged inside the output part. The carrier of the eccentric oscillating speed reducer has at least one of a configuration in which the carrier is attached to the base to be prevented from rotating in response to rotation of the first arm rotated by the output part of the eccentric oscillating speed reducer in a case in which the eccentric oscillating speed reducer is provided to the first joint, and a configuration in which the carrier is attached to the first arm to be prevented from rotating in response to rotation of the second arm rotated by the output part of the eccentric oscillating speed reducer in a case in which the eccentric oscillating speed reducer is provided to the second joint, the electric motor is attached to the carrier. The carrier includes a first carrier part arranged on a side opposite to the base or first arm side in an extension direction of a rotation axis of the eccentric rotating part, and a second carrier part connected to the first carrier part and arranged on the base or first arm side in the extension direction of the rotation axis of the eccentric rotating part, the second carrier part is attached to the base or the first arm, and the electric motor is attached to the first carrier part or the second carrier part.

A robot according to a third aspect of the present disclosure includes a base; a first arm relatively rotatably attached to the base: a second arm relatively rotatably attached to the first arm; a first joint serving as a part connecting the first arm and the base to each other: a second joint serving as a part connecting the first arm and the second arm to each other; an electric motor; and an eccentric oscillating speed reducer including an input part configured to be rotated by a driving force of the electric motor, an eccentric rotating part configured to receive rotation of the input part that is decelerated and transmitted to the eccentric rotating part, an output part configured to receive rotation of the eccentric rotating part that is decelerated and transmitted to the output part, and a carrier arranged inside the output part. The carrier of the eccentric oscillating speed reducer has at least one of a configuration in which the carrier is attached to the base to be prevented from rotating in response to rotation of the first arm rotated by the output part of the eccentric oscillating speed reducer in a case in which the eccentric oscillating speed reducer is provided to the first joint, and a configuration in which the carrier is attached to the first arm to be prevented from rotating in response to rotation of the second arm rotated by the output part of the eccentric oscillating speed reducer in a case in which the eccentric oscillating speed reducer is provided to the second joint, the electric motor is attached to the carrier. Also, the robot further comprises an electric-motor holder that is attached to the carrier with the electric-motor holder being holding the electric motor, and an oil seal that is arranged between the electric-motor holder and the first arm in a case in which the eccentric oscillating speed reducer is provided to the first joint, or between the electric-motor holder and the second arm in a case in which the eccentric oscillating speed reducer is provided to the second joint.

According to the present disclosure, as discussed above, it is possible to simplify a configuration of the robot by using general-purpose wiring, which is more widely used.

### BRIEF DESCRIPTION OF THE DRAWINGS

FIG. 1 is a side view of a SCARA robot according to a first embodiment;

FIG. 2 is a plan view of the SCARA robot according to the first embodiment;

FIG. 3 is an enlarged cross-sectional view of a part K in FIG. 1;

FIG. 4 is a schematic cross-sectional view of a speed reducer of the SCARA robot according to the first embodiment;

FIG. 5 is an enlarged cross-sectional view a joint connecting a first arm to a second arm of a SCARA robot according to a second embodiment;

FIG. 6 is an enlarged cross-sectional view a joint connecting a base to a first arm of a SCARA robot according to a third embodiment;

FIG. 7 is a plan view a joint connecting a base to a first arm of a SCARA robot according to a fourth embodiment;

FIG. 8 is an enlarged cross-sectional view a joint connecting a base to a first arm of a SCARA robot according to a fifth embodiment;

FIG. 9 is an enlarged cross-sectional view a joint connecting a base to a first arm of a SCARA robot according to a sixth embodiment;

FIG. 10 is an enlarged cross-sectional view a joint connecting a base to a first arm of a SCARA robot according to a seventh embodiment;

FIG. 11 is a schematic cross-sectional view of a first speed reducer of the SCARA robot according to the seventh embodiment;

FIG. 12 is an enlarged cross-sectional view a joint connecting a base to a first arm of a SCARA robot according to an eighth embodiment;

FIG. 13 is a schematic cross-sectional view of a first speed reducer of the SCARA robot according to the eighth embodiment;

FIG. 14 is an enlarged cross-sectional view a joint connecting a base to a first arm of a SCARA robot according to a ninth embodiment;

FIG. 15 is a schematic cross-sectional view of a first speed reducer of the SCARA robot according to the ninth embodiment;

FIG. 16 is an enlarged cross-sectional view a joint connecting a base to a first arm of a SCARA robot according to a tenth embodiment;

FIG. 17 is an enlarged cross-sectional view a joint connecting a base to a first arm of a SCARA robot according to an eleventh embodiment;

FIG. 18 is an enlarged cross-sectional view a joint connecting a base to a first arm of a SCARA robot according to a twelfth embodiment;

FIG. 19 is an enlarged cross-sectional view a joint connecting a base to a first arm of a SCARA robot according to a thirteenth embodiment;

FIG. 20 is a schematic cross-sectional view of a first speed reducer of the SCARA robot according to a first modified embodiment of the seventh to ninth embodiments;

FIG. 21 is a schematic cross-sectional view of a first speed reducer of the SCARA robot according to a second modified embodiment of the seventh to ninth embodiments;

FIG. 22 is a schematic cross-sectional view of a first speed reducer of the SCARA robot according to a third modified embodiment of the seventh and eighth embodiments;

FIG. 23 is a schematic cross-sectional view of a first speed reducer of the SCARA robot according to a fourth modified embodiment of the seventh and eighth embodiments;

FIG. 24 is a schematic cross-sectional view of a first speed reducer of the SCARA robot according to a fifth modified embodiment of the seventh and eighth embodiments;

FIG. 25 is a schematic cross-sectional view of a first speed reducer of the SCARA robot according to a sixth modified embodiment of the seventh and eighth embodiments; and

FIG. 26 is an enlarged cross-sectional view of a joint connecting a base to a first arm of a SCARA robot according to a seventh embodiment of the sixth embodiment.

### DETAILED DESCRIPTION

Embodiments embodying the present disclosure will be described with reference to the drawings.

### First Embodiment

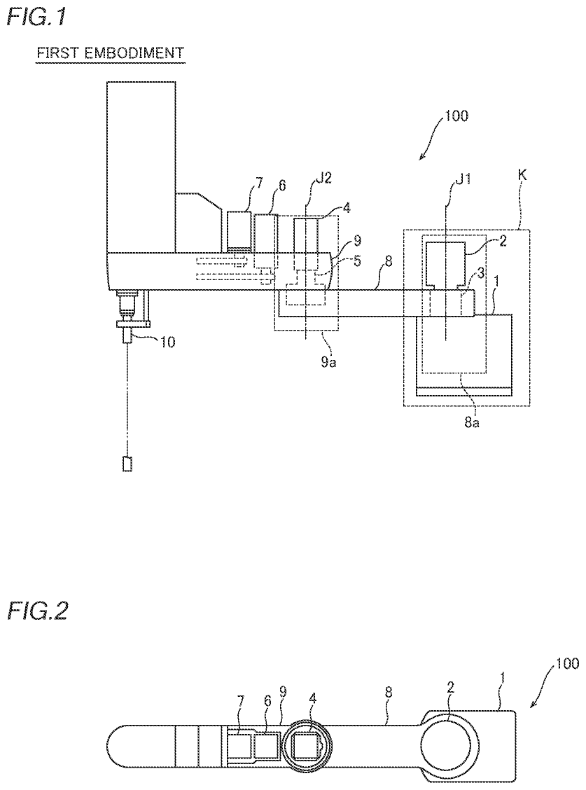

The following description describes a configuration of a SCARA robot 100 according to a first embodiment of the present disclosure with reference to FIGS. 1 to 4. The SCARA robot 100 is an example of a “robot” in the claims.

### (Configuration of SCARA Robot)

As shown in FIGS. 1 and 2, the SCARA robot 100 is a robot including an arm configured to move in a horizontal direction. The SCARA robot 100 includes a base 1, a first electric motor 2, a first speed reducer 3, a second electric motor 4, a second speed reducer 5, a third electric motor 6, a fourth electric motor 7, a first arm 8, a second arm 9, and a working unit 10. The first electric motor 2 is an example of an “electric motor” in the claims.

The base 1 is a base mount for fixing the SCARA robot 100 to an installation surface. The first electric motor 2 is a driving source configured to generate a driving force to drive the first arm 8. The first speed reducer 3 is configured to reduce a speed of rotation of the first electric motor 2. The second electric motor 4 is a driving source configured to generate a driving force to drive the second arm 9. The second speed reducer 5 is configured to reduce a speed of rotation of the second electric motor 4. The third electric motor 6 is a driving source configured to drive an upward/downward mover (not shown) for moving the working unit 10 upward and downward. The fourth electric motor 7 is a driving source configured to drive a rotational driver (not shown) for rotating the working unit 10.

The first arm 8 is relatively rotatably attached to the base 1. The first arm 8 is configured to be rotated about a rotation axis J1 by decelerating and transmitting rotation of the first electric motor 2 by using the first speed reducer 3. The second arm 9 relatively rotatably attached to the first arm 8. The second arm 9 is configured to be rotated about the rotation axis J2 by decelerating and transmitting rotation of the second electric motor 4 by using by the second speed reducer 5.

Here, a first joint 8a is provided in a part connecting the first arm 8 to the base 1. The first joint 8a is formed by connecting the first arm 8 side part of the base 1 to the base 1 side part of the first arm 8. Also, a second joint 9a connecting the first arm 8 to the second arm 9 is provided. The second joint 9a is formed by connecting the first arm 8 side part of the second arm 9 to the first arm 8 side part of the second arm 9.

According to this configuration, the working unit 10 can perform desired operation by combination of rotation of the first arm 8, rotation of the second arm 9, upward/downward movement of upward/downward mover (not shown), and rotation of the rotational driver (not shown) in the SCARA robot 100.

### <Joint Structure Connecting Base to First Arm>

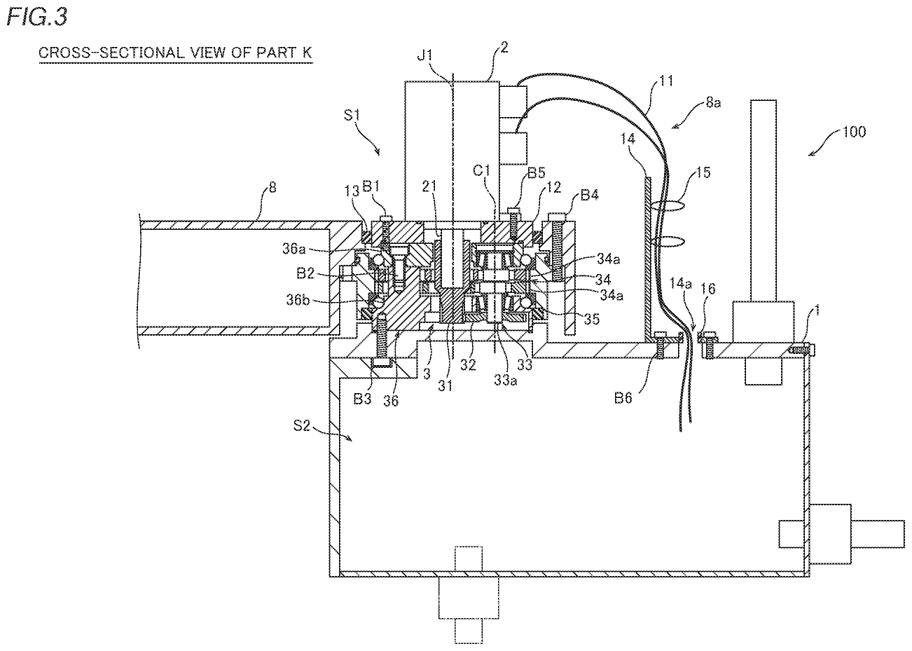

In the SCARA robot 100 according to the first embodiment, the first electric motor 2 does not rotate together with the first arm 8 even when the first arm 8 rotates to perform desired operation by using the working unit 10, as shown in FIG. 3. Accordingly, a wire set 11 connected to the first electric motor 2 does not rotate in response to rotation of the first arm 8, and as a result the wire set 11 can be arranged at a fixed placement position. The following description describes the joint structure (first joint 8a) connecting the base 1 to the first arm 8.

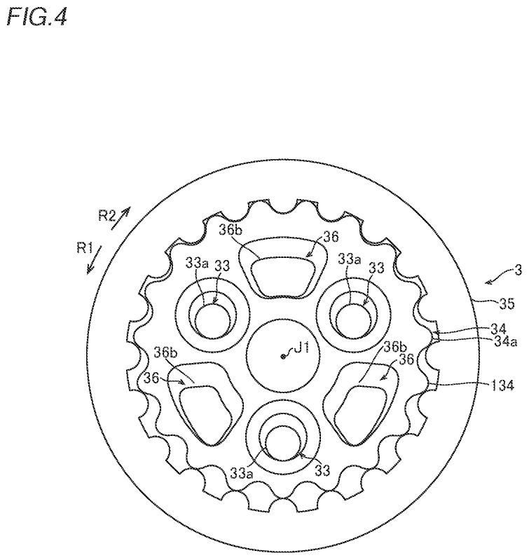

As shown in FIGS. 3 and 4, the SCARA robot 100 includes the aforementioned base 1, the aforementioned first electric motor 2, the aforementioned first speed reducer 3, the aforementioned first arm 8, the wire set 11, an electric-motor holder 12, an oil seal 13, a stay 14, clamps 15, and a grommet 16.

The first speed reducer 3 is an eccentric oscillating speed reducer. In particular, the first speed reducer 3 is an RV (Rotate Vector) speed reducer. The first speed reducer 3 is provided to the first joint 8a. The first speed reducer 3 includes an input part 31, a spur gear 32, an eccentric rotating part 33, an external gear part 34, an output part 35, and a carrier 36.

The input part 31 includes an input gear to which a shaft 21 of the first electric motor 2 is connected. The input part 31 is configured to be rotated by a driving force of the first electric motor 2. The spur gear 32 is configured to transmit a driving force of the input part 31 to the eccentric rotating part 33. The spur gear 32 is arranged on the base 1 side of the eccentric rotating part 33 in an extension direction of a rotation axis C1 of the eccentric rotating part 33.

The eccentric rotating part 33 includes a plurality of (two or three) crankshafts 33a. The rotation of the input part 31 is decelerated and transmitted to the eccentric rotating part 33 by the spur gear 32. The external gear part 34 includes a plurality of (two) RV gears 34a. The RV gear 34a has external teeth 134 meshing with the output part 35. The RV gear 34a is configured to decelerate and transmit the rotation of the crankshaft 33a to the output part 35 by oscillating in response to the rotation of the crankshaft 33a with RV gear being attached to the carrier 36 to be able to oscillate. The output part 35 is a case. The output part 35 is configured to be rotated about the rotation axis J1 in an R1 or R2 direction by oscillation of the RV gear 34a.

As shown in FIG. 3, the carrier 36 is arranged inside the output part 35. The carrier 36 is attached to the base 1 to be prevented from rotating in response to rotation of the first arm 8 rotated by the output part 35 of the first speed reducer 3. The first electric motor 2 is attached to the carrier 36.

Specifically, the carrier 36 includes a first carrier part 36a and a second carrier part 36b. The first carrier part 36a is arranged on a side opposite to the base 1 side in an extension direction of the rotation axis of J1 of the eccentric rotating part 33. One first electric motor 2 is attached to the first carrier part 36a. The first electric motor 2 is fastened by fasteners B1 to be fixed to the first carrier part 36a. The second carrier part 36b is connected to the first carrier part 36a by fasteners B2, pins (not shown), etc. The second carrier part 36b is arranged on the base 1 side in the extension direction of the rotation axis J1 of the eccentric rotating part 33. The second carrier part 36b is attached to the base 1. That is, the second carrier part 36b is fixed to the base 1 by fasteners B3.

As a result, the first electric motor 2 does not rotate in response to rotation of the first arm 8.

The first arm 8 is configured to rotate together with the output part 35 by connecting the output part 35 to the first arm. The first arm 8 is fixed to the output part 35 by fasteners B4. Accordingly, the first arm 8 is relatively rotatably attached to the base 1 with the first speed reducer 3 being connected between the first arm and the base. The wire set 11 includes electric-motor wires connected to the first electric motor 2.

The electric-motor holder 12 is a frame formed of a metal such as aluminum. The electric-motor holder 12 is arranged on a side of the first carrier part 36a opposite to the base 1. The electric-motor holder 12 is attached to the carrier 36 while holding the first electric motor 2. That is, the electric-motor holder 12 is fastened to the first carrier part 36a by the fasteners B1 while holding the first electric motor 2. The first electric motor 2 is fastened to the electric-motor holder 12 by fasteners B5. The first electric motor 2 is arranged in exterior space S1 of the base 1 and fixed to the carrier 36 with the electric-motor holder 12. The first electric motor 2 is arranged on a side of the electric-motor holder 12 opposite to the base 1.

The oil seal 13 is arranged between the electric-motor holder 12 and the first arm 8. The oil seal 13 is arranged on a side opposite to the base 1 side in a part between the electric-motor holder 12 and the first arm 8. The stay 14 is fixed to the base 1 by fasteners B6. The stay 14 supports the wire set 11. The stay 14 has a through hole 14a formed to connect interior space S2 of the base 1 to exterior space S1 of the base 1. Each clamp 15 serves as a member for attaching the wire set 11 to the stay 14. The grommet 16 is attached to the stay 14 to pass the wire set 11 through the stay 14.

### (Advantages of First Embodiment)

In the first embodiment, the following advantages are obtained.

In the first embodiment, as described above, the eccentric oscillating speed reducer 3 is provided to the first joint 8a. Here, the carrier 36 of the eccentric oscillating speed reducer 3 is attached to the base 1 to be prevented from rotating in response to rotation of the first arm 8 rotated by the output part 35 of the eccentric oscillating speed reducer 3. The first electric motor 2 is attached to the carrier 36. According to this configuration, because the first electric motor 2 does not rotate (does not pivot) together with the first arm 8, special wiring such as a movable harness for connection of the electric motor is not necessarily provided for repeated movements of the wire set 11 connected to the first electric motor 2. As a result, it is possible to simplify a configuration of the SCARA robot 100 by using the general-purpose wire set 11, which is more widely used.

Also, in the first embodiment, as described above, the carrier 36 is attached to the base 1 to be prevented from rotating in response to rotation of the first arm 8. The first electric motor 2 is attached to the carrier 36. Also, because the first electric motor 2 does not rotate (does not pivot) together with the first arm 8, a wiring route of the wire set 11 connected to the first electric motor 2 and extending from first electric motor 2 into the base 1 can be a fixed route. For this reason, it is possible to reduce increase of wiring space required to place the wire set 11 (to make the wiring route of the wire set fixed) as compared with a case in which the first electric motor 2 rotates together with the first arm 8. Consequently, it is possible to easily place the wire set 11 connected to the first electric motor 2 in the base 1.

Also, in the first embodiment, as described above, the SCARA robot 100 includes the electric-motor holder 12 attached to the carrier 36 with the electric motor holder holding the first electric motor 2. Accordingly, even in a case in which space is not enough to directly attach the first electric motor 2 to the carrier 36, because the first electric motor 2 can be attached to the carrier 36 by using the electric-motor holder 12, it is possible to securely attach the first electric motor 2 to the carrier 36.

Also, in the first embodiment, as described above, the carrier 36 is attached to the base 1 to be prevented from rotating in response to rotation of the first arm 8. The first electric motor 2 is arranged in exterior space S1 of the base 1 and fixed to the carrier 36 with the electric-motor holder 12. Accordingly, because the first electric motor 2 can be cooled by outside air, it is possible to efficiently cool the first electric motor 2 as compared with a configuration in which the first electric motor 2 is arranged inside the base 1.

Also in the first embodiment, as described above, the SCARA robot 100 includes the oil seal 13 arranged between the first arm 8 and the electric-motor holder 12. Accordingly, even in a case in which the first arm 8 is rotated by rotating the output part 35 while the first electric motor 2 arranged in the exterior space S1 of the base 1 is attached to the carrier 36, it is possible to prevent leakage of grease used in the first speed reducer 3 through a gap between the carrier 36 and the output part 35 to the outside.

Also, in the first embodiment, as described above, one first electric motor 2 is provided. The carrier 36 includes the first carrier part 36a arranged on a side opposite to the base 1 side in the extension direction of the rotation axis C1 of the eccentric rotating part 33, and the second carrier part 36b connected to the first carrier part 36a and arranged on the base 1 side in the extension direction of the rotation axis C1 of the eccentric rotating part 33. The second carrier part 36b is attached to the base 1. The first electric motor 2 is attached to the first carrier part 36a. Accordingly, because the second carrier part 36b is attached to the base 1 so that the second carrier part 36b does not rotate together with the first arm 8, the first carrier part 36a connected to the second carrier part 36b does not rotate together with the first arm 8. Consequently, it is possible to easily attach the first electric motor 2 configured not to rotate together with the first arm 8 to the carrier 36.

Also, in the first embodiment, as described above, because the first electric motor 2 is fixed to the base 1 with the carrier 36, the base 1 does not necessarily have a shape for avoiding interference with the first arm 8, and as a result it is possible to prevent a shape of the base 1 from becoming complicated. As a result, the decrease in the rigidity of base 1 can be suppressed.

Also, in the first embodiment, as described above, because the first electric motor 2 is arranged in the exterior space S1 of the base 1, operators can easily do maintenance on the first electric motor 2. Also, because the interior space S2 of the base 1 can be wider a compared with a case in which the first electric motor 2 is arranged inside the base 1, a robot cable can be easily arranged on a lower side of the interior space S2 of the base 1. Also, because a vertical dimension of the interior space S2 of the base 1 can be smaller as compared with a case in which the first electric motor 2 is arranged in the base 1, a vertical dimension of the SCARA robot 100 can also be smaller.

### Second Embodiment

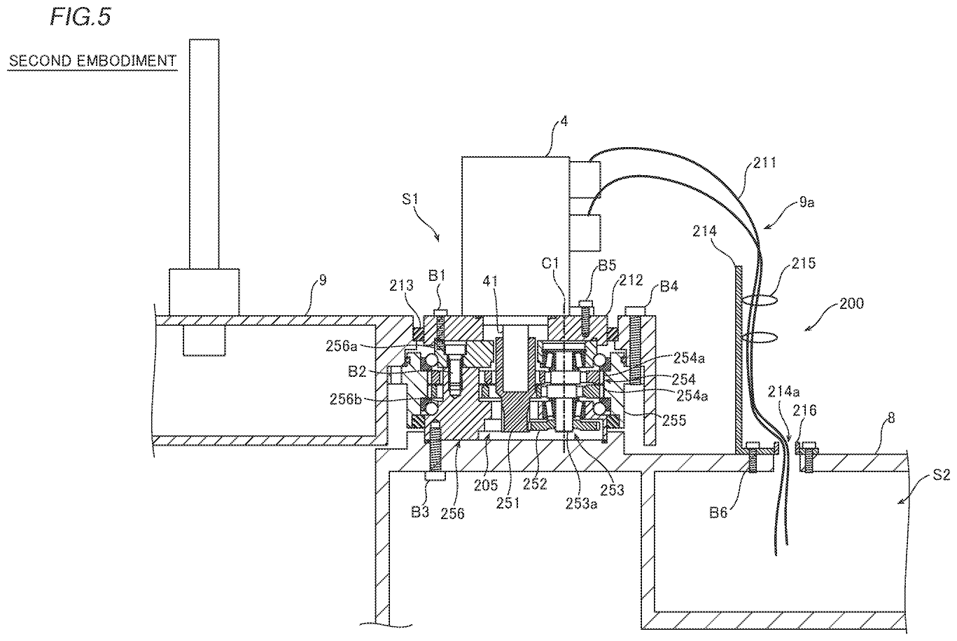

The following description describes a configuration of a SCARA robot 200 according to a second embodiment with reference to FIG. 5. In the second embodiment, dissimilar to the first embodiment, a second speed reducer 205 is attached to the first arm 8. The same configurations in the second embodiment as those of the first embodiment are denoted by the same reference numerals, and their description is omitted.

The following description describes a configuration of the SCARA robot 200 according to the second embodiment of the present disclosure with reference to FIG. 5. The SCARA robot 200 is an example of the “robot” in the claims.

### (Configuration of SCARA Robot)

As shown in FIG. 5, the SCARA robot 200 is a robot including an arm configured to move in a horizontal direction. The SCARA robot 200 includes a base 1 (see FIG. 1), a first electric motor 2 (see FIG. 1), a first speed reducer 3 (see FIG. 1), a second electric motor 4, a second speed reducer 205, a third electric motor 6 (see FIG. 1), a fourth electric motor 7 (see FIG. 1), a first arm 8, a second arm 9, and a working unit 10 (see FIG. 1). The second electric motor 4 is an example of the “electric motor” in the claims.

Here, a first joint 8a (see FIG. 1) is provided in a part connecting the first arm 8 to the base 1. Also, a second joint 9a connecting the first arm 8 to the second arm 9 is provided.

### <Joint Structure Connecting First Arm to Second Arm>

In the SCARA robot 200 according to the second embodiment, the second electric motor 4 does not rotate together with the second arm 9 even when the second arm 9 rotates to perform desired operation by using the working unit 10, as shown in FIG. 5. Accordingly, a wire set 211 connected to the second electric motor 4 does not rotate in response to rotation of the second arm 9, and as a result the wire set 211 can be arranged at a fixed placement position. The following description describes the joint structure (second joint 9a) connecting the first arm 8 to the second arm 9.

As shown in FIG. 5, the SCARA robot 200 includes the aforementioned second electric motor 4, the aforementioned second speed reducer 205, and the aforementioned first arm 8, the aforementioned second arm 9, a wire set 211, an electric-motor holder 212, an oil seal 213, a stay 214, clamps 215, and a grommet 216.

The second speed reducer 205 is an eccentric oscillating speed reducer. In particular, the second speed reducer 205 is an RV speed reducer. The second speed reducer 205 is provided to the second arm 9. The second speed reducer 205 includes an input part 251, a spur gear 252, an eccentric rotating part 253, an external gear part 254, an output part 255, and a carrier 256.

The input part 251 includes an input gear to which a shaft 41 of the second electric motor 4 is connected. The input part 251 is configured to be rotated by a driving force of the second electric motor 4. The spur gear 252 is configured to transmit a driving force of the input part 251 to the eccentric rotating part 253. The spur gear 252 is arranged on the first arm 8 side of the eccentric rotating part 253 in an extension direction of a rotation axis C1 of the eccentric rotating part 253.

The eccentric rotating part 253 includes a plurality of (two or three) crankshafts 253a. The rotation of the input part 251 is decelerated and transmitted to the eccentric rotating part 253 by the spur gear 252. The external gear part 254 includes a plurality of (two) RV gears 254a. The RV gear 254a has external teeth (not shown) meshing with the output part 255. The RV gear 254a is configured to decelerate and transmit the rotation of the crankshaft 253a to the output part 255 by oscillating in response to the rotation of the crankshaft 253a with RV gear being attached to the carrier 256 to be able to oscillate. The output part 255 is a case. The output part 255 is configured to be rotated by oscillation of the RV gear 254a.

The carrier 256 is arranged inside the output part 255. The carrier 256 is attached to the first arm 8 to be prevented from rotating in response to rotation of the second arm 9 rotated by the output part 255 of the second speed reducer 205. The second electric motor 4 is attached to the carrier 256.

Specifically, the carrier 256 includes a first carrier part 256a and a second carrier part 256b. The first carrier part 256a is arranged on a side opposite to the first arm 8 side in an extension direction of the rotation axis of C1 of the eccentric rotating part 253. One second electric motor 4 is attached to the first carrier part 256a. The second electric motor 4 is fastened by fasteners B1 to be fixed to the second carrier part 256b. The second carrier part 256b is connected to the second carrier part 256b by fasteners B2, pins (not shown), etc. The second carrier part 256b is arranged on the first arm 8 side in the extension direction of the rotation axis C1 of the eccentric rotating part 253. The second carrier part 256b is attached to the first arm 8. That is, the second carrier part 256b is fixed to the first arm 8 by fasteners B3.

As a result, the second electric motor 4 does not rotate in response to rotation of the second arm 9.

The second arm 9 is configured to rotate together with the output part 255 by connecting the output part 255 to the second arm. The second arm 9 is fixed to the output part 255 by fasteners B4. Accordingly, the second arm 9 is relatively rotatably attached to the first arm 8 with the second speed reducer 205 being connected between the second arm and the first arm. The wire set 211 includes electric-motor wires connected to the second electric motor 4.

The electric-motor holder 212 is a frame formed of a metal such as aluminum. The electric-motor holder 212 is arranged on a side of the first carrier part 256a opposite to the first arm 8. The electric-motor holder 212 is attached to the carrier 256 while holding the second electric motor 4. That is, the electric-motor holder 212 is fastened to the first carrier part 256a by the fasteners B1 while holding the second electric motor 4. The second electric motor 4 is fastened to the electric-motor holder 212 by fasteners B5. The second electric motor 4 is arranged in exterior space S1 of the first arm 8 and fixed to the carrier 256 with the electric-motor holder 212. The second electric motor 4 is arranged on a side of the electric-motor holder 212 opposite to the first arm 8.

The oil seal 213 is arranged between the electric-motor holder 212 and the second arm 9. The oil seal 213 is arranged on a side opposite to the first arm 8 side in a part between the electric-motor holder 212 and the second arm 9. The stay 214 is fixed to the first arm 8 by fasteners B6. The stay 214 supports the wire set 211. The stay 214 has a through hole 214a formed to connect interior space S2 of the first arm 8 to exterior space S1 of the first arm 8. Each clamp 215 serves as a member for attaching the wire set 211 to the stay 214. The grommet 216 is attached to the stay 214 to pass the wire set 211 through the stay 214. The other configuration of the second embodiment is similar to the configuration of the aforementioned first embodiment.

### (Advantages of Second Embodiment)

In the second embodiment, similar to the aforementioned first embodiment, the second speed reducer 205 is provided to the second joint 9a. Here, the carrier 256 of the second speed reducer 205 is attached to the first arm 8 to be prevented from rotating in response to rotation of the second arm 9 rotated by the output part 255 of the second speed reducer 205. The second electric motor 4 is attached to the carrier 256. Accordingly, it is possible to simplify a configuration of the SCARA robot 200 by using the general-purpose wire set 211, which is more widely used. The other advantages of the second embodiment are similar to the advantages of the aforementioned first embodiment.

### Third Embodiment

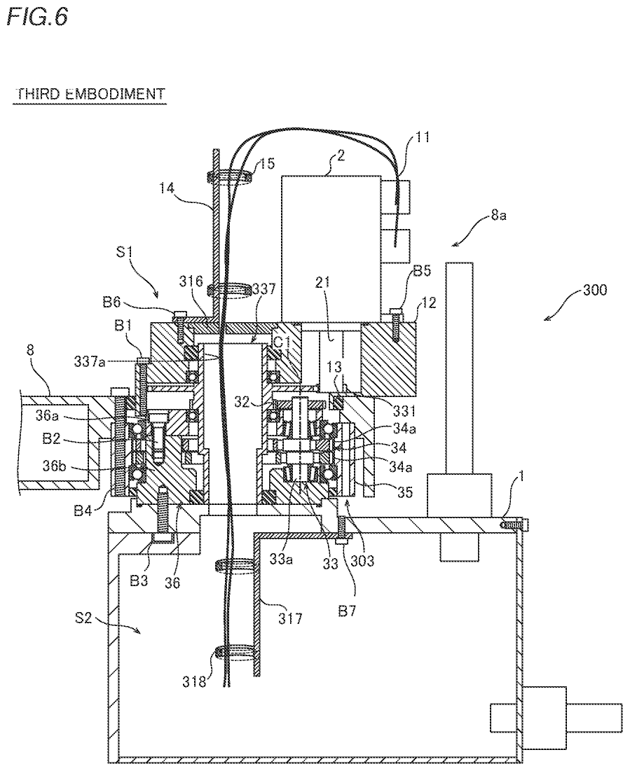

The following description describes a configuration of a SCARA robot 300 according to a third embodiment with reference to FIG. 6. In the third embodiment, a first speed reducer 303 includes a hollow transmission shaft 337 dissimilar to the first embodiment. Description of the same configurations in the third embodiment as those of the first embodiment is omitted.

The following description describes a configuration of the SCARA robot 300 according to the third embodiment of the present disclosure with reference to FIG. 6. The SCARA robot 300 is an example of the “robot” in the claims.

### (Configuration of SCARA Robot)

As shown in FIG. 6, the SCARA robot 300 is a robot including an arm configured to move in a horizontal direction. The SCARA robot 300 includes a base 1, a first electric motor 2, a first speed reducer 303, a second electric motor 4 (see FIG. 1), a second speed reducer 5 (see FIG. 1), a third electric motor 6 (see FIG. 1), a fourth electric motor 7 (see FIG. 1), a first arm 8, a second arm 9, and a working unit 10 (see FIG. 1). The first electric motor 2 is an example of the “electric motor” in the claims.

Here, a first joint 8a is provided in a part connecting the first arm 8 to the base 1. Also, a second joint 9a (see FIG. 1) connecting the first arm 8 to the second arm 9 is provided.

### <Joint Structure Connecting Base to First Arm>

In the SCARA robot 300 according to the third embodiment, the first electric motor 2 does not rotate together with the first arm 8 even when the first arm 8 rotates to perform desired operation by using the working unit 10, as shown in FIG. 6. Accordingly, a wire set 11 connected to the first electric motor 2 does not rotate in response to rotation of the first arm 8, and as a result the wire set 11 can be arranged at a fixed placement position. The following description describes the joint structure (first joint 8a) connecting the base 1 to the first arm 8.

As shown in FIG. 6, the SCARA robot 300 includes the aforementioned base 1, the aforementioned first electric motor 2, the aforementioned first speed reducer 303, the aforementioned first arm 8, the wire set 11, an electric-motor holder 12, an oil seal 13, a stay 14, clamps 15, and a grommet 316, a stay 317 and clamps 318.

The first speed reducer 303 is an eccentric oscillating speed reducer. In particular, the first speed reducer 303 is an RV speed reducer. The first speed reducer 303 includes an input part 331, a spur gear 32, an eccentric rotating part 33, an external gear part 34, an output part 35, a carrier 36, and the transmission shaft 337.

The input part 331 includes an input gear to which a shaft 21 of the first electric motor 2 is connected. The input part 331 is configured to be rotated by a driving force of the first electric motor 2. The transmission shaft 337 has a hollow shape having a through hole 337a that extends in the extension direction of the rotation axis C1 of the eccentric rotating part 33. The transmission shaft 337 is connected to the input part 331, and is configured to transmit a driving force from the first electric motor 2 to the eccentric rotating part 33 through the spur gear 32. Accordingly, an input gear of the input part 331 meshes with a gear of the transmission shaft 337. Alternatively, the input part 331 and the transmission shaft 337 can be connected to each other by pulleys and a belt.

The spur gear 32 is configured to transmit a driving force of the transmission shaft 337 to the eccentric rotating part 33. The spur gear 32 is arranged on a side of the eccentric rotating part 33 opposite to the base 1 side in an extension direction of a rotation axis C1 of the eccentric rotating part 33.

The eccentric rotating part 33 includes a plurality of (two or three) crankshafts 33a. The rotation of the input part 331 is decelerated and transmitted to the eccentric rotating part 33 by the spur gear 32. The external gear part 34 includes a plurality of (two) RV gears 34a. The RV gear 34a has external teeth (not shown) meshing with the output part 35. The RV gear 34a is configured to decelerate and transmit the rotation of the crankshaft 33a to the output part 35 by oscillating in response to the rotation of the crankshaft 33a with RV gear being attached to the carrier 36 to be able to oscillate. The output part 35 is a case. The output part 35 is configured to be rotated by oscillation of the RV gear 34a.

As shown in FIG. 6, the carrier 36 is arranged inside the output part 35. The carrier 36 is attached to the base 1 to be prevented from rotating in response to rotation of the first arm 8 rotated by the output part 35 of the first speed reducer 303. The first electric motor 2 is attached to the carrier 36.

Specifically, the carrier 36 includes a first carrier part 36a and a second carrier part 36b. The first carrier part 36a is arranged on a side opposite to the base 1 side in an extension direction of the rotation axis of C1 of the eccentric rotating part 33. One first electric motor 2 is attached to the first carrier part 36a. The first electric motor 2 is fastened by fasteners B1 to be fixed to the first carrier part 36a. The second carrier part 36b is connected to the first carrier part 36a by fasteners B2, pins (not shown), etc. The second carrier part 36b is arranged on the base 1 side in the extension direction of the rotation axis C1 of the eccentric rotating part 33. The second carrier part 36b is attached to the base 1. That is, the second carrier part 36b is fixed to the base 1 by fasteners B3.

As a result, the first electric motor 2 does not rotate in response to rotation of the first arm 8.

Here, the first electric motor 2 is arranged at an offset position offset from a center of the first carrier part 36a in a radial direction orthogonal to the extension direction of the rotation axis C1 of the eccentric rotating part 33.

The wire set 11 includes electric-motor wires connected to the first electric motor 2. The wire set 11 is connected to the first electric motor 2 with the wire set passing through the through hole 337a.

The electric-motor holder 12 is a frame formed of a metal such as aluminum. The electric-motor holder 12 is arranged on a side of the first carrier part 36a opposite to the base 1. The electric-motor holder 12 is attached to the carrier 36 while holding the first electric motor 2. That is, the electric-motor holder 12 is fastened to the first carrier part 36a by the fasteners B1 while holding the first electric motor 2. The first electric motor 2 is fastened to the electric-motor holder 12 by fasteners B5. The first electric motor 2 is arranged in exterior space S1 of the base 1 and fixed to the carrier 36 with the electric-motor holder 12. The first electric motor 2 is arranged on a side of the electric-motor holder 12 opposite to the base 1.

The oil seal 13 is arranged between the electric-motor holder 12 and the first arm 8. The oil seal 13 is arranged on a side opposite to the base 1 side in a part between the electric-motor holder 12 and the first arm 8. The stay 14 is fixed to the base 1 by fasteners B6. The stay 14 supports the wire set 11. Each clamp 15 serves as a member for attaching the wire set 11 to the stay 14. The grommet 316 covers the through hole 337a. The grommet 316 is attached to electric-motor holder 12 to pass the wire set 11 through the through hole 337a. The stay 317 supports the wire set 11. The stay 317 is fixed to the base 1 by fasteners B7. Each clamp 318 serves as a member for attaching the wire set 11 to the stay 317. The other configuration of the third embodiment is similar to the configuration of the aforementioned first embodiment.

### (Advantages of Third Embodiment)

In the third embodiment, similar to the aforementioned first embodiment, the first speed reducer 303 is provided to the first joint 8a. Here, the carrier 36 of the first speed reducer 303 is attached to the base 1 to be prevented from rotating in response to rotation of the first arm 8 rotated by the output part 35 of the first speed reducer 303. The first electric motor 2 is attached to the carrier 36. Accordingly, it is possible to simplify a configuration of the SCARA robot 300 by using the general-purpose wire set 11, which is more widely used.

In the third embodiment, as described above, the first electric motor 2 is arranged at an offset position offset from a center of the first carrier part 36a in a radial direction orthogonal to the extension direction of the rotation axis C1 of the eccentric rotating part 33. Accordingly, because the first electric motor 2 does not cover a central part of the first carrier part 36a in the radial direction orthogonal to the extension direction of the rotation axis C1 of the eccentric rotating part 33, the central part of the first carrier part 36a can be used for a particular use such as passage of the wire set 11.

In addition, in the third embodiment, as described above, the first speed reducer 303 includes the hollow transmission shaft 337 having a through hole 337a extending in the extension direction of the rotation axis C1 of the eccentric rotating part 33 and connected to the input part 331 to transmit the driving force from the first electric motor 2 to the eccentric rotating part 33. The SCARA robot 300 includes the wire set 11 connected to the first electric motor 2 with the wire set passing through the through hole 337a. Accordingly, because the wire set 11 can be accommodated in the first carrier part 36a dissimilar to a configuration in which the wire set 11 is placed outside the first carrier part 36a, it is possible to reduce exposure of the wire set 11. The other advantages of the third embodiment are similar to the advantages of the aforementioned first embodiment.

### Fourth Embodiment

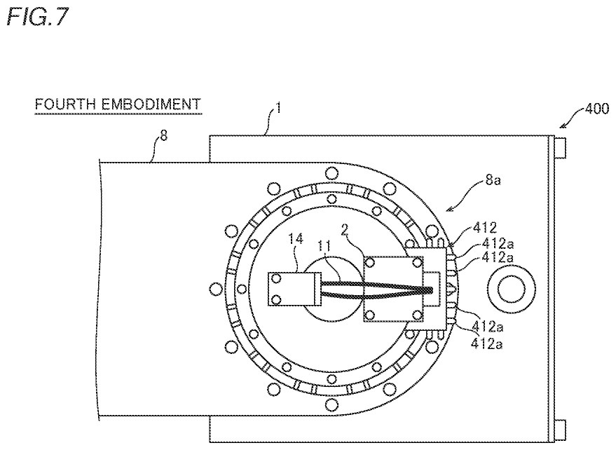

The following description describes a configuration of a SCARA robot 400 according to a fourth embodiment with reference to FIG. 7. In the fourth embodiment, the electric-motor holder 412 includes fins 412a, dissimilar to the third embodiment. Description of the same configurations in the fourth embodiment as those of the third embodiment is omitted.

The following description describes a configuration of the SCARA robot 400 according to the fourth embodiment of the present disclosure with reference to FIG. 7. The SCARA robot 400 is an example of the “robot” in the claims.

### (Configuration of SCARA Robot)

As shown in FIG. 7, the SCARA robot 400 is a robot including an arm configured to move in a horizontal direction. The SCARA robot 400 includes a base 1, a first electric motor 2, a first speed reducer 303 (see FIG. 6), a second electric motor 4 (see FIG. 6), a second speed reducer 5 (see FIG. 1), a third electric motor 6 (see FIG. 1), a fourth electric motor 7 (see FIG. 1), a first arm 8, a second arm 9, and a working unit 10 (see FIG. 1). The first electric motor 2 is an example of the “electric motor” in the claims.

Here, a first joint 8a is provided in a part connecting the first arm 8 to the base 1. Also, a second joint 9a (see FIG. 1) connecting the first arm 8 to the second arm 9 is provided.

### <Joint Structure Connecting Base to First Arm>

In the SCARA robot 400 according to the fourth embodiment, the first electric motor 2 does not rotate together with the first arm 8 even when the first arm 8 rotates to perform desired operation by using the working unit 10. Accordingly, a wire set 11 connected to the first electric motor 2 does not rotate in response to rotation of the first arm 8, and as a result the wire set 11 can be arranged at a fixed placement position. The following description describes the joint structure (first joint 8a) connecting the base 1 to the first arm 8.

As shown in FIG. 7, the SCARA robot 400 includes the aforementioned base 1, the aforementioned first electric motor 2, the aforementioned first speed reducer 303, the aforementioned first arm 8, the wire set 11, an electric-motor holder 412, an oil seal 13, a stay 14, clamps 15, and a grommet 316.

The electric-motor holder 412 is a frame formed of a metal such as aluminum. the electric motor holder 412 includes the protruding fins 412a formed an exterior surface of the electric motor holder. The other configuration of the fourth embodiment is similar to the configuration of the aforementioned third embodiment.

### (Advantages of Fourth Embodiment)

In the fourth embodiment, similar to the aforementioned third embodiment, the first speed reducer 303 is provided to the first joint 8a. Here, the carrier 36 of the first speed reducer 303 is attached to the base 1 to be prevented from rotating in response to rotation of the first arm 8 rotated by the output part 35 of the first speed reducer 303. The first electric motor 2 is attached to the carrier 36. Accordingly, it is possible to simplify a configuration of the SCARA robot 400 by using the general-purpose wire set 11, which is more widely used.

Also, in the fourth embodiment, as described above, the electric motor holder 412 includes the protruding fins 412a formed the exterior surface of the electric motor holder. Accordingly, because the electric motor holder 412 can be efficiently cooled by the protruding fins 412a, it is possible to efficiently cool the first electric motor 2 held by the electric-motor holder 412. The other advantages of the fourth embodiment are similar to the advantages of the aforementioned third embodiment.

### Fifth Embodiment

The following description describes a configuration of a SCARA robot 500 according to a fifth embodiment with reference to FIG. 8. In the fifth embodiment, dissimilar to the third embodiment, a base 501 includes a base-side venting part 501a. Description of the same configurations in the fifth embodiment as those of the third embodiment is omitted.

The following description describes a configuration of the SCARA robot 500 according to the fifth embodiment of the present disclosure with reference to FIG. 8. The SCARA robot 500 is an example of the “robot” in the claims.

### (Configuration of SCARA Robot)

As shown in FIG. 8, the SCARA robot 500 is a robot including an arm configured to move in a horizontal direction. The SCARA robot 500 includes a base 501, a first electric motor 2, a first speed reducer 303, a second electric motor 4 (see FIG. 1), a second speed reducer 5 (see FIG. 1), a third electric motor 6 (see FIG. 1), a fourth electric motor 7 (see FIG. 1), a first arm 8, a second arm 9, and a working unit 10 (see FIG. 1). The first electric motor 2 is an example of the “electric motor” in the claims.

Here, a first joint 508a is provided in a part connecting the first arm 8 to the base 501. Also, a second joint 9a (see FIG. 1) connecting the first arm 8 to the second arm 9 is provided.

### <Joint Structure Connecting Base to First Arm>

In the SCARA robot 500 according to the fifth embodiment, the first electric motor 2 does not rotate together with the first arm 8 even when the first arm 8 rotates to perform desired operation by using the working unit 10, as shown in FIG. 8. Accordingly, a wire set 11 connected to the first electric motor 2 does not rotate in response to rotation of the first arm 8, and as a result the wire set 11 can be arranged at a fixed placement position. The following description describes the joint structure (first joint 508a) connecting the base 501 to the first arm 8.

As shown in FIG. 8, the SCARA robot 500 includes the aforementioned base 501, the aforementioned first electric motor 2, the aforementioned first speed reducer 303, the aforementioned first arm 8, the wire set 11, an electric-motor holder 12, an oil seal 13, a stay 14, clamps 15, a grommet 316, a stay 517, clamps 518, and a shaft cover 519.

The base 501 includes a base-side venting part 501a configured to provide ventilation between interior space S2 of the base 501 and exterior space S1 of the base 501. The base-side venting part 501a has slits. Alternatively, the base-side venting part 501a can be a filter.

The stay 517 is fixed to the base 501 by fasteners B7. The stay 517 supports the wire set 11. The stay 517 is fixed to the base 501 by fasteners B7. Each clamp 518 serves as a member for attaching the wire set 11 to the stay 517.

The shaft cover 519 covers the first electric motor 2 side of the through hole 337a of the transmission shaft 337 in the extension direction of the rotation axis C1 of the eccentric rotating part 33. The shaft cover 519 includes a speed-reducer-side venting part 519a configured to provide ventilation between interior space S2 of the base 501 and exterior space S1 of the base 501 through the through hole 337a. The speed-reducer-side venting part 519a has slits. Alternatively, the speed-reducer-side venting part 519a can be a filter.

Accordingly, air can flow through the base-side venting part 501a, the interior space S2 of the base 501, the through hole 337a, and the speed-reducer-side venting part 519a to the exterior space S1 of the base 501 in this order. The other configuration of the fifth embodiment is similar to the configuration of the aforementioned third embodiment.

### (Advantages of Fifth Embodiment)

In the fifth embodiment, similar to the aforementioned third embodiment, the first speed reducer 303 is provided to the first joint 508a. Here, the carrier 36 of the first speed reducer 303 is attached to the base 501 to be prevented from rotating in response to rotation of the first arm 8 rotated by the output part 35 of the first speed reducer 303. The first electric motor 2 is attached to the carrier 36. Accordingly, it is possible to simplify a configuration of the SCARA robot 500 by using the general-purpose wire set 11, which is more widely used.

In addition, in the fifth embodiment, as described above, the base 501 includes the base-side venting part 501a configured to provide ventilation between interior space S2 of the base 501 and exterior space S1 of the base 501. The SCARA robot 500 includes the shaft cover 519 covering the first electric motor 2 side of the through hole 337a of the transmission shaft 337 in the extension direction of the rotation axis C1 of the eccentric rotating part 33 and having a speed-reducer-side venting part 519a configured to provide ventilation between the interior space S2 of the base 501 and the exterior space S1 of the base 501 through the through hole 337a. According to this configuration, because air can flow through the base-side venting part 501a, the through hole 337a of the transmission shaft 337 and the speed-reducer-side venting part 519a of the shaft cover 519, it is possible to efficiently cool the first eccentric oscillating speed reducer 303. The other advantages of the fifth embodiment are similar to the advantages of the aforementioned third embodiment.

### Sixth Embodiment

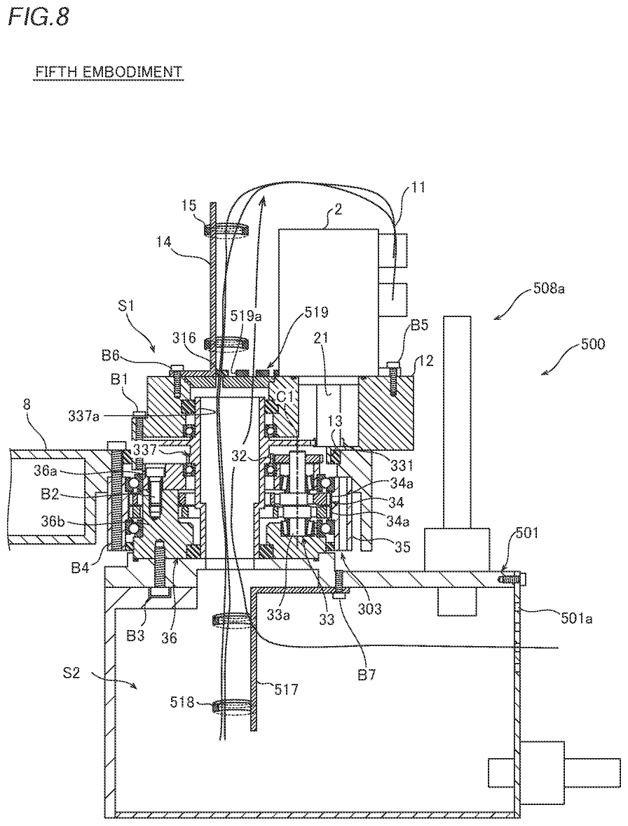

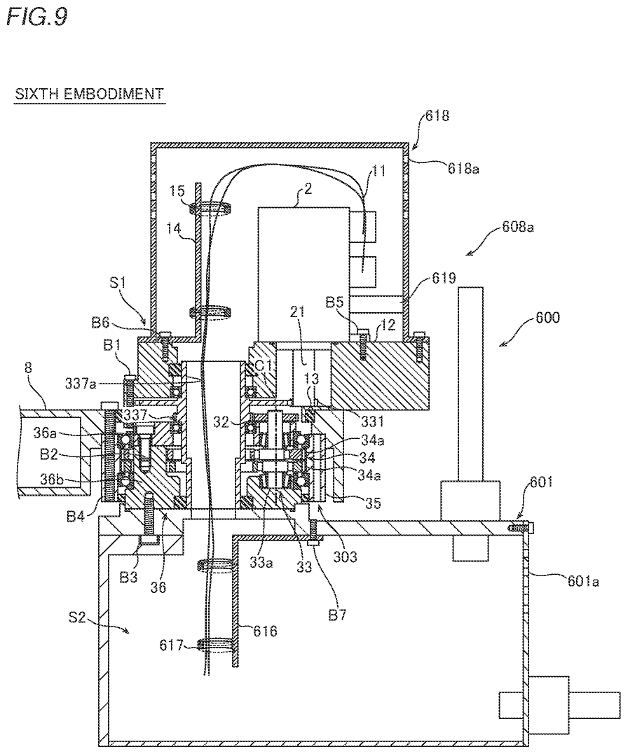

The following description describes a configuration of a SCARA robot 600 according to a sixth embodiment with reference to FIG. 9. In the sixth embodiment, dissimilar to the third embodiment, the SCARA robot 600 includes an electric-motor cover 618. Description of the same configurations in the sixth embodiment as those of the third embodiment is omitted.

The following description describes a configuration of the SCARA robot 600 according to the sixth embodiment of the present disclosure with reference to FIG. 9. The SCARA robot 600 is an example of the “robot” in the claims.

### (Configuration of SCARA Robot)

As shown in FIG. 9, the SCARA robot 600 is a robot including an arm configured to move in a horizontal direction. The SCARA robot 600 includes a base 601, a first electric motor 2, a first speed reducer 303, a second electric motor 4, a second speed reducer 5 (see FIG. 1), a third electric motor 6 (see FIG. 1), a fourth electric motor 7 (see FIG. 1), a first arm 8, a second arm 9, and a working unit 10 (see FIG. 1). The first electric motor 2 is an example of the “electric motor” in the claims.

Here, a first joint 608a is provided in a part connecting the first arm 8 to the base 601. Also, a second joint 9a (see FIG. 1) connecting the first arm 8 to the second arm 9 is provided.

### <Joint Structure Connecting Base to First Arm>

In the SCARA robot 600 according to the sixth embodiment, the first electric motor 2 does not rotate together with the first arm 8 even when the first arm 8 rotates to perform desired operation by using the working unit 10, as shown in FIG. 9. Accordingly, a wire set 11 connected to the first electric motor 2 does not rotate in response to rotation of the first arm 8, and as a result the wire set 11 can be arranged at a fixed placement position. The following description describes the joint structure (first joint 608a) connecting the base 601 to the first arm 8.

As shown in FIG. 9, the SCARA robot 600 includes the aforementioned base 601, the aforementioned first electric motor 2, the aforementioned first speed reducer 303, the aforementioned first arm 8, the wire set 11, an electric-motor holder 12, an oil seal 13, a stay 14, clamps 15, a stay 616, clamps 617, the electric-motor cover 618 and a heat conductor 619.

The base 601 includes a base-side venting part 601a configured to provide ventilation between interior space S2 of the base 601 and exterior space S1 of the base 601. The base-side venting part 601a has slits. Alternatively, the base-side venting part 601a can be a filter.

The stay 616 is fixed to the base 601 by fasteners B7. The stay 616 supports the wire set 11. Each clamp 617 serves as a member for attaching the wire set 11 to the stay 616.

The electric-motor cover 618 covers the first electric motor 2. The electric-motor cover 618 includes an electric-motor side venting part 618a configured to provide ventilation between interior space S2 of the base 601 and exterior space S1 of the base 601 through the through hole 337a of the transmission shaft 337. The electric-motor side venting part 618a has slits. Alternatively, the electric-motor side venting part 618a can be a filter.

Accordingly, air can flow through the base-side venting part 601a, the interior space S2 of the base 601, the through hole 337a, and the electric-motor side venting part 618a to the exterior space S1 of the base 601 in this order.

The heat conductor 619 serves as a member that transfers heat from the first electric motor 2 to the electric-motor cover 618. Accordingly, the first electric motor 2 and the electric-motor cover 618 are connected to each other through the heat conductor 619. The other configuration of the sixth embodiment is similar to the configuration of the aforementioned third embodiment.

### (Advantages of Sixth Embodiment)

In the sixth embodiment, similar to the aforementioned third embodiment, the first speed reducer 303 is provided to the first joint 608a. Here, the carrier 36 of the first speed reducer 303 is attached to the base 601 to be prevented from rotating in response to rotation of the first arm 8 rotated by the output part 35 of the first speed reducer 303. The first electric motor 2 is attached to the carrier 36. Accordingly, it is possible to simplify a configuration of the SCARA robot 600 by using the general-purpose wire set 11, which is more widely used.

In addition, in the sixth embodiment, as described above, the base 601 includes the base-side venting part 601a configured to provide ventilation between interior space S2 of the base 601 and exterior space S1 of the base 601. The SCARA robot 600 includes the electric-motor cover 618 covering the first electric motor 2 and having an electric-motor side venting part 618a configured to provide ventilation between the interior space S2 of the base 601 and the exterior space S1 of the base 601 through the through hole 337a. According to this configuration, because dust resistance of the first electric motor 2 can be improved by the electric-motor cover 618 covering the first electric motor 2 while air can flow from the base-side venting part 601a to the electric-motor side venting part 618a, it is possible to efficiently cool the first electric motor 2 in the electric-motor cover 618.

Also, in the sixth embodiment, as described above, the first electric motor 2 and the electric-motor cover 618 are connected to each other through the heat conductor 619. Accordingly, because transfer of heat from the first electric motor 2 to the electric-motor cover 618 is enhanced, it is possible to efficiently cool the first electric motor 2 in the electric-motor cover 618. The other advantages of the sixth embodiment are similar to the advantages of the aforementioned third embodiment.

### Seventh Embodiment

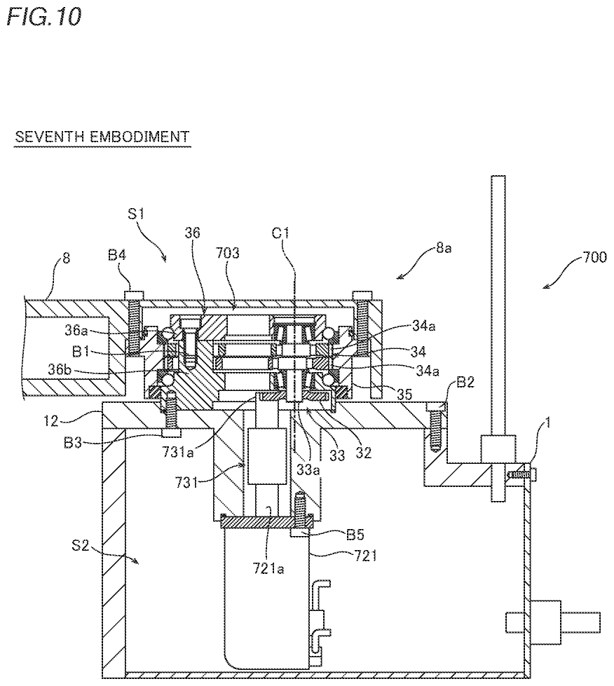

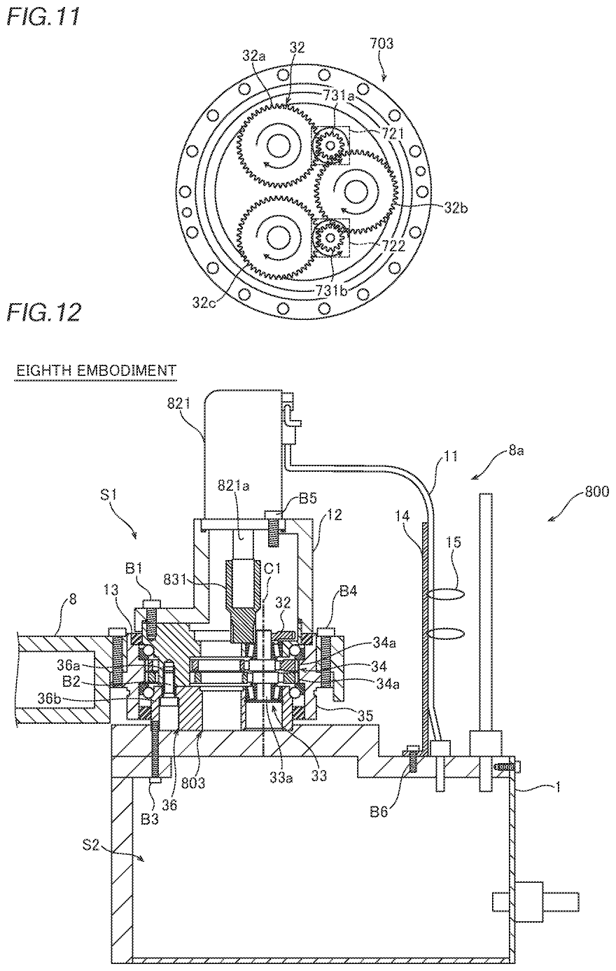

The following description describes a configuration of a SCARA robot 700 according to a seventh embodiment with reference to FIGS. 10 and 11. In the seventh embodiment, dissimilar to the first embodiment, the SCARA robot 700 drives a first speed reducer 703 by using a first electric motor 721 and a second electric motor 722. Description of the same configurations in the seventh embodiment as those of the first embodiment is omitted.

The following description describes a configuration of a SCARA robot 700 according to a seventh embodiment of the present disclosure with reference to FIGS. 10 and 11. The SCARA robot 700 is an example of the “robot” in the claims.

### (Configuration of SCARA Robot)

As shown in FIGS. 10 and 11, the SCARA robot 700 is a robot including an arm configured to move in a horizontal direction. The SCARA robot 700 includes a base 1, a first electric motor 721, a second electric motor 722, a first speed reducer 703, a third electric motor 4 (see FIG. 1), a second speed reducer 5 (see FIG. 1), a fourth electric motor 6 (see FIG. 1), a fifth electric motor 7 (see FIG. 1), a first arm 8, a second arm 9, and a working unit 10 (see FIG. 1). The first electric motor 721 and the second electric motor 722 are examples of the “electric motor” in the claims.

Here, a first joint 8a is provided in a part connecting the first arm 8 to the base 1. Also, a second joint 9a (see FIG. 1) connecting the first arm 8 to the second arm 9 is provided.

### <Joint Structure Connecting Base to First Arm>

In the SCARA robot 700 according to the seventh embodiment, the first electric motor 721 and the second electric motor 722 do not rotate together with the first arm 8 even when the first arm 8 rotates to perform desired operation by using the working unit 10, as shown in FIG. 10. Accordingly, wire sets (not shown) connected to the first electric motor 721 and the second electric motor 722 do not rotate in response to rotation of the first arm 8, and as a result the wire set can be arranged at a fixed placement position. The following description describes the joint structure (first joint 8a) connecting the base 1 to the first arm 8.

As shown in FIG. 10 and FIG. 11, the SCARA robot 700 includes the aforementioned base 1, the aforementioned first electric motor 721, the aforementioned second electric motor 722, the aforementioned first speed reducer 703, the aforementioned first arm 8, and an electric-motor holder 12.

The first electric motor 721 and the second electric motor 722 are configured to be rotated in synchronization with each other by a controller (not shown). The controller is configured to synchronize rotation of the first electric motor 721 and rotation of the second electric motor 722 based on a rotation angle of a rotor of the first electric motor 721 acquired by a resolver and a rotation angle of a rotor of the second electric motor 722 acquired by a resolver. The controller includes a CPU (central processing unit) and a storage such as a memory and a hard disk drive.

The first speed reducer 703 is an eccentric oscillating speed reducer. In particular, the first speed reducer 703 is an RV speed reducer. The first speed reducer 703 is attached to the first arm 8. The first speed reducer 703 includes an input part 731, a spur gear 32, an eccentric rotating part 33, an external gear part 34, an output part 35, and a carrier 36.

The input part 731 includes a first input gear 731a connected to a shaft 721a of the first electric motor 721, and a second input gear 731b connected to a shaft (not shown) of the second electric motor 722 as shown in FIG. 11. The first input gear 731a is configured to be rotated by a driving force of the first electric motor 721. The second input gear 731b is configured to be rotated by a driving force of the second electric motor 722.

A plurality of spur gears 32 are configured to transmit driving forces of the input part 731 to the eccentric rotating part 33. The number of the spur gears 32 is three. The spur gears 32 are arranged on the base 1 side of the eccentric rotating part 33 in an extension direction of a rotation axis C1 of the eccentric rotating part 33. The plurality of spur gears 32 includes a first spur gear 32a, a second spur gear 32b, and a third spur gear 32c. The first spur gear 32a and the second spur gear 32b are connected to the first electric motor 721 through the first input gear 731a. The second spur gear 32b and the third spur gear 32c are connected to the second electric motor 722 through the second input gear 731b.

The eccentric rotating part 33 includes a plurality of (three) crankshafts 33a. The rotation of the input part 31 is decelerated and transmitted to the eccentric rotating part 33 by the spur gear 32. The plurality of crankshafts 33a are configured to be rotated by driving forces of the first electric motor 721 and the second electric motor 722.

As shown in FIG. 10, the carrier 36 is arranged inside the output part 35. The carrier 36 is attached to the base 1 to be prevented from rotating in response to rotation of the first arm 8 rotated by the output part 35 of the first speed reducer 703. The first electric motor 721 and the second electric motor 722 are attached to the carrier 36.

Specifically, the carrier 36 includes a first carrier part 36a and a second carrier part 36b. The first carrier part 36a is arranged on a side opposite to the base 1 side in an extension direction of the rotation axis of C1 of the eccentric rotating part 33. The second carrier part 36b is connected to the first carrier part 36a by fasteners B1, pins (not shown), etc. The second carrier part 36b is arranged on the base 1 side in the extension direction of the rotation axis C1 of the eccentric rotating part 33. The second carrier part 36b is attached to the base 1. The second carrier part 36b is fastened by fasteners B2 to be fixed to the base 1 with the electric-motor holder 12.

Both the first electric motor 721 and the second electric motor 722 are attached the second carrier part 36b. The first electric motor 721 and the second electric motor 722 are fastened by fasteners B3 to be fixed to the second carrier part 36b with the electric-motor holder 12.

As a result, the first electric motor 721 and the second electric motor 722 do not rotate in response to rotation of the first arm 8.

The first arm 8 is configured to rotate together with the output part 35 by connecting the output part 35 to the first arm. The first arm 8 is fixed to the output part 35 by fasteners B4. Accordingly, the first arm 8 is relatively rotatably attached to the base 1 with the first speed reducer 703 being connected between the first arm and the base.

The electric-motor holder 12 is a frame formed of a metal such as aluminum. The electric-motor holder 12 is arranged on the base 1 side of the second carrier part 36b. The electric-motor holder 12 is attached to the carrier 36 while holding the first electric motor 721 and the second electric motor 722. That is, the electric-motor holder 12 is fastened to the second carrier part 36b by the fasteners B3 while holding the first electric motor 721 and the second electric motor 722. The first electric motor 721 and the second electric motor 722 are fastened to the electric-motor holder 12 by the fasteners B5. Both the first electric motor 721 and the second electric motor 722 are attached to the second carrier part 36b with the first electric motor and the second electric motor being arranged in the interior space S2 of the base 1. The other configuration of the seventh embodiment is similar to the configuration of the aforementioned first embodiment.

### (Advantages of Seventh Embodiment)

In the seventh embodiment, similar to the aforementioned first embodiment, the first speed reducer 703 is provided to the first joint 8a. Here, the carrier 36 of the first speed reducer 703 is attached to the base 1 to be prevented from rotating in response to rotation of the first arm 8 rotated by the output part 35 of the first speed reducer 703. The first electric motor 2 is attached to the carrier 36. Accordingly, it is possible to simplify a configuration of the SCARA robot 700 by using the general-purpose wire set 11, which is more widely used.

Also, in the seventh embodiment, as described above, the first electric motor 721 and the second electric motor 722 are configured to rotate in synchronization with each other synchronously with each other. The eccentric rotating part 33 includes a plurality of crankshafts 33a. The plurality of crankshafts 33a are configured to be rotated by driving forces of the first electric motor 721 and the second electric motor 722. Accordingly, it is possible to increase a driving force of the first speed reducer 703 as compared with a configuration in which the plurality of crankshafts 33a are rotated by a single electric motor. As a result, it is possible to increase an available weight that can be rotated by the first speed reducer 703.

In the seventh embodiment, as described above, the carrier 36 includes the first carrier part 36a arranged a side opposite to the base 1 side in an extension direction of a rotation axis C1 of the crankshaft 33a, and the second carrier part 36b connected to the first carrier part 36a and arranged the base 1 side in the extension direction of the rotation axis C1 of the crankshaft 33a. The first electric motor 721 is attached to the second carrier part 36b, and the second electric motor 722 is attached to the second carrier part 36b. Accordingly, because the second carrier part 36b is attached to the base 1 so that the second carrier part 36b does not rotate together with the first arm 8, the first carrier part 36a connected to the second carrier part 36b does not rotate together with the first arm 8. Consequently, it is possible to easily attach the first electric motor 721 and the second electric motor 722, which do not rotate together with the first arm 8, to the carrier 36.

Also, in the seventh embodiment, as described above, the second carrier part 36b is attached to the base 1. Both the first electric motor 721 and the second electric motor 722 are attached to the second carrier part 36b with the first electric motor and the second electric motor being arranged in the interior space S2 of the base 1. Accordingly, because both the first electric motor 721 and the second electric motor 722 can be placed in the interior space S2 of the base 1 without rotating together with the first arm 8, it is possible to prevent interference between the first electric motor 721 and the second electric motor 722, and other components placed in the interior space S2 of the base 1 as compared with a case in which the first electric motor 721 and the second electric motor 722 rotate together with the first arm 8.

Also, in the seventh embodiment, as described above, the first spur gear 32a and the second spur gear 32b are connected to the first electric motor 721 through the first input gear 731a. The second spur gear 32b and the third spur gear 32c are connected to the second electric motor 722 through the second input gear 731b. Accordingly, a load and friction of the first speed reducer 703 applied to the first electric motor 721 can be substantially equal to a load and friction of the first speed reducer 703 applied to the second electric motor 722. Also, load inertia of the first speed reducer 703 applied to the first electric motor 721 can be substantially equal to load inertia of the first speed reducer 703 applied to the second electric motor 722. The other advantages of the seventh embodiment are similar to the advantages of the aforementioned first embodiment.

### Eighth Embodiment

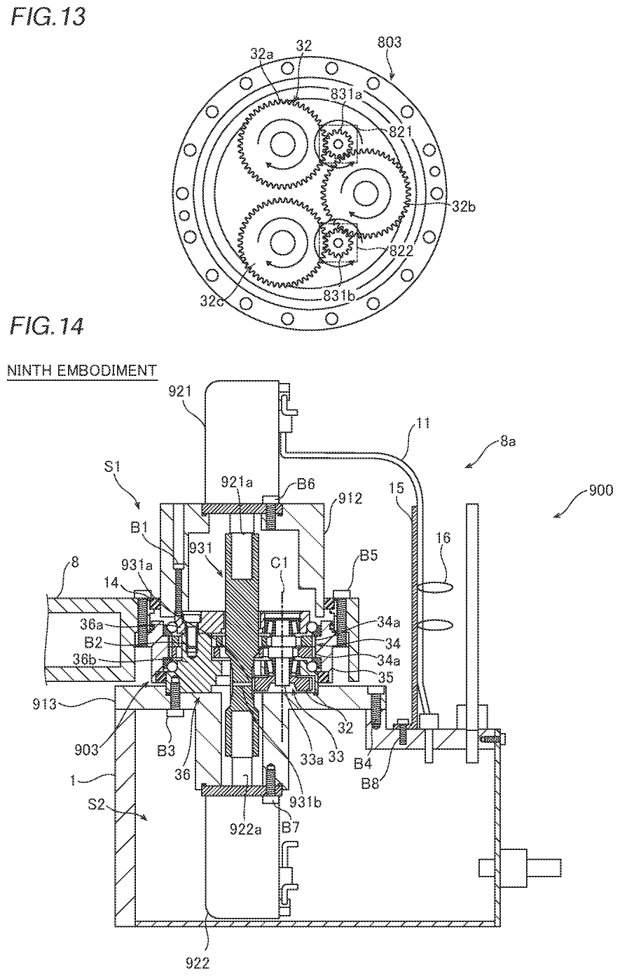

The following description describes a configuration of a SCARA robot 800 according to an eighth embodiment with reference to FIGS. 12 and 13. In the eighth embodiment, dissimilar to the first embodiment, the SCARA robot 800 drives a first speed reducer 803 by using a first electric motor 821 and a second electric motor 822. Description of the same configurations in the eighth embodiment as those of the first embodiment is omitted.

The following description describes a configuration of the SCARA robot 800 according to the eighth embodiment of the present disclosure with reference to FIGS. 12 and 13. The SCARA robot 800 is an example of the “robot” in the claims.

### (Configuration of SCARA Robot)

As shown in FIGS. 12 and 13, the SCARA robot 800 is a robot including an arm configured to move in a horizontal direction. The SCARA robot 800 includes a base 1, a first electric motor 821, a second electric motor 822, a first speed reducer 803, a third electric motor 4 (see FIG. 1), a second speed reducer 5 (see FIG. 1), a fourth electric motor 6 (see FIG. 1), a fifth electric motor 7 (see FIG. 1), a first arm 8, a second arm 9, and a working unit 10 (see FIG. 1). The first electric motor 821 and the second electric motor 822 are examples of the “electric motor” in the claims.

Here, a first joint 8a is provided in a part connecting the first arm 8 to the base 1. Also, a second joint 9a (see FIG. 1) connecting the first arm 8 to the second arm 9 is provided.

### <Joint Structure Connecting Base to First Arm>

In the SCARA robot 800 according to the eighth embodiment, the first electric motor 821 and the second electric motor 822 do not rotate together with the first arm 8 even when the first arm 8 rotates to perform desired operation by using the working unit 10, as shown in FIG. 12. Accordingly, wire sets 11 connected to the first electric motor 821 and the second electric motor 822 do not rotate in response to rotation of the first arm 8, and as a result the wire set 11 can be arranged at a fixed placement position. The following description describes the joint structure (first joint 8a) connecting the base 1 to the first arm 8.

As shown in FIGS. 12 and 13, the SCARA robot 800 includes the aforementioned base 1, the aforementioned first electric motor 821, the aforementioned second electric motor 822, the aforementioned first speed reducer 803, the aforementioned first arm 8, the wire set 11, an electric-motor holder 12, an oil seal 13, a stay 14, and clamps 15.

The first electric motor 821 and the second electric motor 822 are configured to be rotated in synchronization with each other by a controller (not shown). The controller is configured to synchronize rotation of the first electric motor 821 and rotation of the second electric motor 822 based on a rotation angle of a rotor of the first electric motor 821 acquired by a resolver and a rotation angle of a rotor of the second electric motor 822 acquired by a resolver. The controller includes a CPU, and a storage such as a memory and a hard disk drive.

The first speed reducer 803 is an eccentric oscillating speed reducer. In particular, the first speed reducer 803 is an RV speed reducer. The first speed reducer 803 is provided to the first joint 8a. The first speed reducer 803 includes an input part 831, a spur gear 32, an eccentric rotating part 33, an external gear part 34, an output part 35, and a carrier 36.

The input part 831 includes a first input gear 831a connected to a shaft 821a of the first electric motor 821, and a second input gear 831b connected to a shaft (not shown) of the second electric motor 822 as shown in FIG. 13. The first input gear 831a is configured to be rotated by a driving force of the first electric motor 821. The second input gear 831b is configured to be rotated by a driving force of the second electric motor 822.

A plurality of spur gears 32 are configured to transmit driving forces of the input part 831 to the eccentric rotating part 33. The number of the spur gears 32 is three. The spur gears 32 are arranged on a side of the eccentric rotating part 33 opposite to the base 1 side in an extension direction of a rotation axis C1 of the eccentric rotating part 33. The plurality of spur gears 32 includes a first spur gear 32a, a second spur gear 32b, and a third spur gear 32c. The first spur gear 32a and the second spur gear 32b are connected to the first electric motor 821 through the first input gear 831a. The second spur gear 32b and the third spur gear 32c are connected to the second electric motor 822 through the second input gear 831b.

The eccentric rotating part 33 includes a plurality of (three) crankshafts 33a. The rotation of the input part 831 is decelerated and transmitted to the eccentric rotating part 33 by the spur gear 32. The plurality of crankshafts 33a are configured to be rotated by driving forces of the first electric motor 821 and the second electric motor 822.

As shown in FIG. 12, the carrier 36 is arranged inside the output part 35. The carrier 36 is attached to the base 1 to be prevented from rotating in response to rotation of the first arm 8 rotated by the output part 35 of the first speed reducer 803. The first electric motor 821 and the second electric motor 822 are attached to the carrier 36.

Specifically, the carrier 36 includes a first carrier part 36a and a second carrier part 36b. The first carrier part 36a is arranged on a side opposite to the base 1 side in an extension direction of the rotation axis of C1 of the eccentric rotating part 33. The first electric motor 821 and the second electric motor 822 are attached to the first carrier part 36a. The first electric motor 821 and the second electric motor 822 are fastened by fasteners B1 to be fixed to the first carrier part 36a. The first electric motor 821 and the second electric motor 822 are fastened by fasteners B1 to be fixed to the first carrier part 36a with the electric-motor holder 12.

The second carrier part 36b is connected to the first carrier part 36a by fasteners B2, pins (not shown), etc. The second carrier part 36b is arranged on the base 1 side in the extension direction of the rotation axis C1 of the eccentric rotating part 33. The second carrier part 36b is attached to the base 1. The second carrier part 36b is fastened by fasteners B3 to be fixed to the base 1.

As a result, the first electric motor 821 and the second electric motor 822 do not rotate in response to rotation of the first arm 8.

The first arm 8 is configured to rotate together with the output part 35 by connecting the output part 35 to the first arm. The first arm 8 is fixed to the output part 35 by fasteners B4. Accordingly, the first arm 8 is relatively rotatably attached to the base 1 with the first speed reducer 803 being connected between the first arm and the base.

The electric-motor holder 12 is a frame formed of a metal such as aluminum. The electric-motor holder 12 is arranged on a side of the first carrier part 36a opposite to the base 1 side. The electric-motor holder 12 is attached to the carrier 36 while holding the first electric motor 821 and the second electric motor 822. That is, the electric-motor holder 12 is fastened to the first carrier part 36a by the fasteners B1 while holding the first electric motor 821 and the second electric motor 822. The first electric motor 821 and the second electric motor 822 are fastened to the electric-motor holder 12 by the fasteners B5. Both the first electric motor 821 and the second electric motor 822 are attached to the first carrier part 36a with the first electric motor and the second electric motor being arranged in the exterior space S1 of the base 1.

The oil seal 13 is arranged between the electric-motor holder 12 and the first arm 8. The oil seal 13 is arranged on a side opposite to the base 1 side in a part between the electric-motor holder 12 and the first arm 8. The stay 14 is fixed to the base 1 by fasteners B6. The other configuration of the eighth embodiment is similar to the configuration of the aforementioned first embodiment.

### (Advantages of Eighth Embodiment)

In the eighth embodiment, similar to the aforementioned first embodiment, the first speed reducer 803 is provided to the first joint 8a. Here, the carrier 36 of the first speed reducer 803 is attached to the base 1 to be prevented from rotating in response to rotation of the first arm 8 rotated by the output part 35 of the first speed reducer 803. The first electric motor 2 is attached to the carrier 36. Accordingly, it is possible to simplify a configuration of the SCARA robot 800 by using the general-purpose wire set 11, which is more widely used.

Also, in the eighth embodiment, as described above, the second carrier part 36b is attached to the base 1. Both the first electric motor 821 and the second electric motor 822 are attached to the first carrier part 36a with the first electric motor and the second electric motor being arranged in the exterior space S1 of the base 1. Accordingly, because the first electric motor 821 and the second electric motor 822 can be cooled by outside air, it is possible to efficiently cool the first electric motor 821 and the second electric motor 822. The other advantages of the eighth embodiment are similar to the advantages of the aforementioned first embodiment.

### Ninth Embodiment

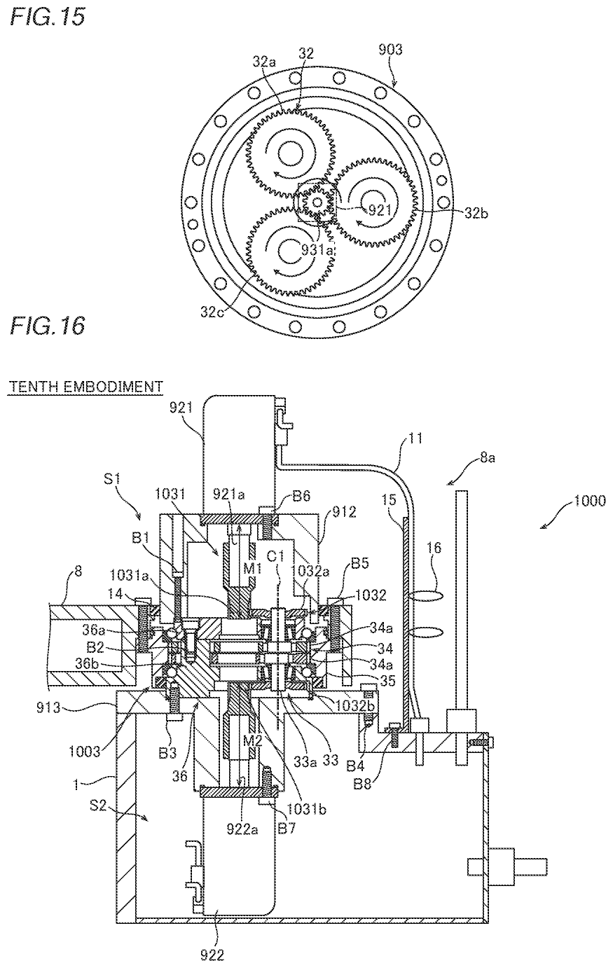

The following description describes a configuration of a SCARA robot 900 according to a ninth embodiment with reference to FIGS. 14 and 15. In the ninth embodiment, dissimilar to the first embodiment, the SCARA robot 900 drives a first speed reducer 903 by using a first electric motor 921 and a second electric motor 922. Description of the same configurations in the ninth embodiment as those of the first embodiment is omitted.

The following description describes a configuration of a SCARA robot 900 according to a ninth embodiment of the present disclosure with reference to FIGS. 14 and 15. The SCARA robot 900 is an example of the “robot” in the claims.

### (Configuration of SCARA Robot)

As shown in FIGS. 14 and 15, the SCARA robot 900 is a robot including an arm configured to move in a horizontal direction. The SCARA robot 900 includes a base 1, a first electric motor 921, a second electric motor 922, a first speed reducer 903, a third electric motor 4 (see FIG. 1), a second speed reducer 5 (see FIG. 1), a fourth electric motor 6 (see FIG. 1), a fifth electric motor 7 (see FIG. 1), a first arm 8, a second arm 9, and a working unit 10 (see FIG. 1). The first electric motor 921 and the second electric motor 922 are examples of the “electric motor” in the claims.

Here, a first joint 8a is provided in a part connecting the first arm 8 to the base 1. Also, a second joint 9a (see FIG. 1) connecting the first arm 8 to the second arm 9 is provided.

### <Joint Structure Connecting Base to First Arm>

In the SCARA robot 900 according to the ninth embodiment, the first electric motor 921 and the second electric motor 922 do not rotate together with the first arm 8 even when the first arm 8 rotates to perform desired operation by using the working unit 10, as shown in FIG. 14. Accordingly, wire sets 11 connected to the first electric motor 921 and the second electric motor 922 do not rotate in response to rotation of the first arm 8, and as a result the wire set 11 can be arranged at a fixed placement position. The following description describes the joint structure (first joint 8a) connecting the base 1 to the first arm 8.

As shown in FIGS. 14 and 15, the SCARA robot 900 includes the aforementioned base 1, the aforementioned first electric motor 921, the aforementioned second electric motor 922, the aforementioned first speed reducer 903, the aforementioned first arm 8, the wire set 11, a first electric-motor holder 912, a second electric-motor holder 913, an oil seal 14, a stay 15, and clamps 16.

The first electric motor 921 and the second electric motor 922 are configured to be rotated in synchronization with each other by a controller (not shown). The controller is configured to synchronize rotation of the first electric motor 921 and rotation of the second electric motor 922 based on a rotation angle of a rotor of the first electric motor 921 acquired by a resolver and a rotation angle of a rotor of the second electric motor 922 acquired by a resolver. The controller includes a CPU, and a storage such as a memory and a hard disk drive.

The first speed reducer 903 is an eccentric oscillating speed reducer. In particular, the first speed reducer 903 is an RV speed reducer. The first speed reducer 903 is provided to the first joint 8a. The first speed reducer 903 includes an input part 931, a spur gear 32, an eccentric rotating part 33, an external gear part 34, an output part 35, and a carrier 36.

The input part 931 includes a first input gear 931a connected to a shaft 921a of the first electric motor 921, and a second input gear 931b connected to a shaft 922a of the second electric motor 922. The first input gear 931a is configured to be rotated by a driving force of the first electric motor 921. The second input gear 931b is configured to be rotated by a driving force of the second electric motor 922.

A plurality of spur gears 32 are configured to transmit driving forces of both the first input gear 931a and the second input gear 931b to the eccentric rotating part 33. The number of the spur gears 32 is three. The spur gears 32 are arranged on the base 1 side of the eccentric rotating part 33 in an extension direction of a rotation axis C1 of the eccentric rotating part 33. The plurality of spur gears 32 includes a first spur gear 32a, a second spur gear 32b, and a third spur gear 32c. The first spur gear 32a, the second spur gear 32b and the third spur gear 32c are connected to the first electric motor 921 through the first input gear 931a, and to the second electric motor 922 through the second input gear 931b.

Accordingly, the first input gear 931a and the second input gear 931b mesh with the plurality of spur gears 32 that are common to the first input gear and the second input gear. The plurality of spur gears 32 that are common to the first input gear and the second input gear are arranged on the base 1 side of each of the plurality of crankshafts 33a with the first input gear 931a being meshing with the first carrier part 36a side of each of the plurality spur gears and the second input gear 931b being meshing with the second carrier part 36b side of each of the plurality of spur gears.

The eccentric rotating part 33 includes a plurality of (three) crankshafts 33a. The rotation of the input part 931 is decelerated and transmitted to the eccentric rotating part 33 by the spur gear 32. The plurality of crankshafts 33a are configured to be rotated by driving forces of the first electric motor 921 and the second electric motor 922.

As shown in FIG. 14, the carrier 36 is arranged inside the output part 35. The carrier 36 is attached to the base 1 to be prevented from rotating in response to rotation of the first arm 8 rotated by the output part 35 of the first speed reducer 903. The first electric motor 921 and the second electric motor 922 are attached to the carrier 36.

Specifically, the carrier 36 includes a first carrier part 36a and a second carrier part 36b.

The first carrier part 36a is arranged on a side opposite to the base 1 side in an extension direction of the rotation axis of C1 of the eccentric rotating part 33. The first electric motor 921 is attached to the first carrier part 36a. The first electric motor 921 is fastened by fasteners B1 to be fixed to the first carrier part 36a with the first electric-motor holder 912.

The second carrier part 36b is connected to the first carrier part 36a by fasteners B2, pins (not shown), etc.

The second carrier part 36b is arranged on the base 1 side in the extension direction of the rotation axis C1 of the eccentric rotating part 33. The second electric motor 922 is attached to the second carrier part 36b. The second electric motor 922 is fastened by fasteners B3 to be fixed to the second carrier part 36b with the second electric-motor holder 913.

The second carrier part 36b is attached to the base 1. The second carrier part 36b is fastened by fasteners B4 to be fixed to the base 1.

As a result, the first electric motor 921 and the second electric motor 922 do not rotate in response to rotation of the first arm 8.

The first arm 8 is configured to rotate together with the output part 35 by connecting the output part 35 to the first arm. The first arm 8 is fixed to the output part 35 by fasteners B5. Accordingly, the first arm 8 is relatively rotatably attached to the base 1 with the first speed reducer 903 being connected between the first arm and the base.

The first electric-motor holder 912 is a frame formed of a metal such as aluminum. The first electric-motor holder 912 is arranged on a side of the first carrier part 36a opposite to the base 1 side. The first electric-motor holder 912 is attached to the carrier 36 while holding the first electric motor 921. That is, the first electric-motor holder 912 is fastened to the first carrier part 36a by the fasteners B1 while holding the first electric motor 921. The first electric motor 921 is fastened to the first electric-motor holder 912 by fasteners B6. The first electric motor 921 is attached to the first carrier part 36a with the first electric motor being arranged in the exterior space S1 of the base 1.

The second electric-motor holder 913 is a frame formed of a metal such as aluminum. The second electric-motor holder 913 is arranged on the base 1 side of the second carrier part 36b. The second electric-motor holder 913 is attached to the carrier 36 while holding the second electric motor 922. That is, the second electric-motor holder 913 is fastened to the second carrier part 36b by the fasteners B3 while holding the second electric motor 922. The second electric motor 922 is fastened to the second electric-motor holder 913 by fasteners B7. The second electric motor 922 is attached to the base 1, to which to the second carrier part 36b is attached, with the second electric motor being arranged in the interior space S2 of the base 1.

The oil seal 14 is arranged between the first electric-motor holder 912 and the first arm 8. The oil seal 14 is arranged on a side opposite to the base 1 side in a part between the first electric-motor holder 912 and the first arm 8. The stay 15 is fixed to the base 1 by fasteners B8. The other configuration of the ninth embodiment is similar to the configuration of the aforementioned first embodiment.

### (Advantages of Ninth Embodiment)

In the ninth embodiment, similar to the aforementioned first embodiment, the first speed reducer 903 is provided to the first joint 8a. Here, the carrier 36 of the first speed reducer 903 is attached to the base 1 to be prevented from rotating in response to rotation of the first arm 8 rotated by the output part 35 of the first speed reducer 903. The first electric motor 2 is attached to the carrier 36. Accordingly, it is possible to simplify a configuration of the SCARA robot 900 by using the general-purpose wire set 11, which is more widely used.

Also, in the ninth embodiment, as described above, the second carrier part 36b is attached to the base 1. The first electric motor 921 is attached to the first carrier part 36a. The second electric motor 922 is attached to the base 1, to which to the second carrier part 36b is attached, with the second electric motor being arranged in the interior space S2 of the base 1. Accordingly, the first electric motor 921 can be attached to the first carrier part 36a without rotating together with the first arm 8, and the second electric motor 922 can be placed in the interior space S2 of the base 1 without rotating together with the first arm 8. Because both the first electric motor 921 and the second electric motor 922 do not rotate together with the first arm 8, it is possible to prevent the first electric motor 921 and the second electric motor 922 from rotating relative to each other. Because rotation speeds of the first electric motor 921 and the second electric motor 922 are not necessarily controlled in consideration of relative rotation between the first electric motor 921 and the second electric motor 922 that occurs due to rotation of the first arm 8, it is possible to easily control the first electric motor 921 and the second electric motor 922 in synchronization with each other.

Also in the ninth embodiment, as discussed above, the input part 931 includes the first input gear 931a connected to the first electric motor 921, and the second input gear 931b connected to the second electric motor 922. The first speed reducer 903 includes the plurality of spur gears 32 that configured to transmit a driving force of the first input gear 931a and a driving force of the second input gear 931b to the plurality of crankshafts 33a. According to this configuration, because the plurality of spur gears 32 can rotate with the plurality of spur gears 32 being meshing with both the first input gear 931a and the second input gear 931b, rotation speeds of the first electric motor 921 and the second electric motor 922 can be reduced by changing the number of teeth of the plurality of spur gears 32, the numbers of teeth of the first input gear 931a and the second input gear 931b so that the rotations can be decelerated to transmitted to the plurality of crankshafts 33a.

Also, in the ninth embodiment, as discussed above, the first input gear 931a and the second input gear 931b mesh with the plurality of spur gears 32 that are common to the first input gear and the second input gear. The plurality of spur gears 32 that are common to the first input gear and the second input gear are arranged on the base 1 side of each of the plurality of crankshafts 33a with the first input gear 931a being meshing with the first carrier part 36a side of each of the plurality spur gears and the second input gear 931b being meshing with the second carrier part 36b side of each of the plurality of spur gears. Accordingly, because both the first input gear 931a and the second input gear 931b can be connected to the plurality of spur gears 32 that are common to the first input gear and the second input gear, a load and friction of the first speed reducer 903 applied to the first electric motor 921 can be substantially equal to a load and friction of the first speed reducer 903 applied to the second electric motor 922. Because the plurality of crankshafts 33a can be rotated similarly to each other by controlling the first electric motor 921 and the second electric motor 922 similarly to each other, it is possible to easily control the first electric motor 921 and the second electric motor 922 in synchronization with each other. In addition, because a load and friction of the first speed reducer 903 applied to the first electric motor 921 can be substantially equal to a load and friction of the first speed reducer 903 applied to the second electric motor 922, it is possible to reduce a difference between a current supplied to the first electric motor 921 and a current supplied to the second electric motor 922. The other advantages of the ninth embodiment are similar to the advantages of the aforementioned first embodiment.

### Tenth Embodiment

The following description describes a configuration of a SCARA robot 1000 according to a tenth embodiment with reference to FIG. 16. In the tenth embodiment, dissimilar to the ninth embodiment, the SCARA robot 1000 includes a first spur gear 1032a and a second spur gear 1032b. Description of the same configurations in the tenth embodiment as those of the ninth embodiment is omitted.

The following description describes a configuration of the SCARA robot 1000 according to the tenth embodiment of the present disclosure with reference to FIG. 16. The SCARA robot 1000 is an example of the “robot” in the claims.

### (Configuration of SCARA Robot)

As shown in FIG. 16, the SCARA robot 1000 is a robot including an arm configured to move in a horizontal direction. The SCARA robot 1000 includes a base 1, a first electric motor 921, a second electric motor 922, a first speed reducer 1003, a third electric motor 4 (see FIG. 1), a second speed reducer 5 (see FIG. 1), a fourth electric motor 6 (see FIG. 1), a fifth electric motor 7 (see FIG. 1), a first arm 8, a second arm 9, and a working unit 10 (see FIG. 1). The first electric motor 921 and the second electric motor 922 are examples of the “electric motor” in the claims.

Here, a first joint 8a is provided in a part connecting the first arm 8 to the base 1. Also, a second joint 9a (see FIG. 1) connecting the first arm 8 to the second arm 9 is provided.

### <Joint Structure Connecting Base to First Arm>

In the SCARA robot 1000 according to the tenth embodiment, the first electric motor 921 and the second electric motor 922 do not rotate together with the first arm 8 even when the first arm 8 rotates to perform desired operation by using the working unit 10. Accordingly, wire sets 11 connected to the first electric motor 921 and the second electric motor 922 do not rotate in response to rotation of the first arm 8, and as a result the wire set 11 can be arranged at a fixed placement position. The following description describes the joint structure (first joint 8a) connecting the base 1 to the first arm 8.

As shown in FIG. 16, the SCARA robot 1000 includes the aforementioned base 1, the aforementioned first electric motor 921, the aforementioned second electric motor 922, the aforementioned first speed reducer 1003, the aforementioned first arm 8, the wire set 11, a first electric-motor holder 912, a second electric-motor holder 913, an oil seal 14, a stay 15, and clamps 16.

The first speed reducer 1003 is an eccentric oscillating speed reducer. In particular, the first speed reducer 1003 is an RV speed reducer. The first speed reducer 1003 is provided to the first joint 8a. The first speed reducer 1003 includes an input part 1031, a spur gear 1032, an eccentric rotating part 33, an external gear part 34, an output part 35, and a carrier 36.

The input part 1031 includes a first input gear 1031a connected to a shaft 921a of the first electric motor 921, and a second input gear 1031b connected to a shaft 922a of the second electric motor 922. The first input gear 1031a is configured to be rotated by a driving force of the first electric motor 921. The second input gear 1031b is configured to be rotated by a driving force of the second electric motor 922.

The plurality of spur gears 1032 includes a first spur gear 1032a, and a second spur gear 1032b. The first spur gear 1032a is arranged on a side of each of the plurality of crankshafts 33a opposite to the base 1 side. The first spur gear 1032a is connected to the first input gear 1031a. The second spur gear 1032b is arranged on the base 1 side of each of the plurality of crankshafts 33a. The second spur gear 1032b is connected to the second input gear 1031b.

An interval M1 between the first electric motor 921 and the first input gear 1031a is substantially equal to an interval M2 between the second electric motor 922 and the second input gear 1031b in an extension direction of the crankshaft 33a. The other configuration of the tenth embodiment is similar to the configuration of the aforementioned ninth embodiment.

### (Advantages of Tenth Embodiment)

In the tenth embodiment, similar to the aforementioned ninth embodiment, the first speed reducer 1003 is provided to the first joint 8a. Here, the carrier 36 of the first speed reducer 1003 is attached to the base 1 to be prevented from rotating in response to rotation of the first arm 8 rotated by the output part 35 of the first speed reducer 1003. The first electric motor 2 is attached to the carrier 36. Accordingly, it is possible to simplify a configuration of the SCARA robot 1000 by using the general-purpose wire set 11, which is more widely used.

Also in the tenth embodiment, as discussed above, the plurality of spur gears 1032 include a first spur gear 1032a arranged on a side of each of the plurality of crankshafts 33a opposite to the base 1 side and connected to the first input gear 1031a, and a second spur gear 1032b arranged on the base 1 side of each of the plurality of crankshafts 33a and connected to the second input gear 1031b. Accordingly, because the first spur gear 1032a can be arranged on a side closer to the first electric motor 921, it is possible to reduce an interval between the first input gear 1031a and the first electric motor 921. Also, because the second spur gear 1032b can be arranged on a side closer to the second electric motor 922, it is possible to reduce an interval between the second input gear 1031b and the second electric motor 922. Accordingly, because a mass of a shaft between the first input gear 1031a and the first electric motor 921 can be reduced while a mass of a shaft between the second input gear 1031b and the second electric motor 922 can be reduced, it is possible to prevent increase of load inertia (moment of load inertia) applied to the first electric motor 921 and the second electric motor 922.

In the tenth embodiment, as discussed above, the interval M1 between the first electric motor 921 and the first input gear 1031a is substantially equal to the interval M2 between the second electric motor 922 and the second input gear 1031b in an extension direction of the crankshaft 33a. Accordingly, because a length of the shaft 921a connecting the first electric motor 921 to the first input gear 1031a can be equal to a length of the shaft 922a connecting the second electric motor 922 to the second input gear 1031b, a mass of the shaft connecting the first electric motor 921 to the first input gear 1031a can be substantially equal to a mass of the shaft connecting the second electric motor 922 to the second input gear 1031b. As a result, inertia (moment of inertia) generated when the first input gear 1031a is rotated can be substantially equal to inertia (moment of inertia) generated when the second input gear 1031b is rotated. The other advantages of the tenth embodiment are similar to the advantages of the aforementioned ninth embodiment.

### Eleventh Embodiment

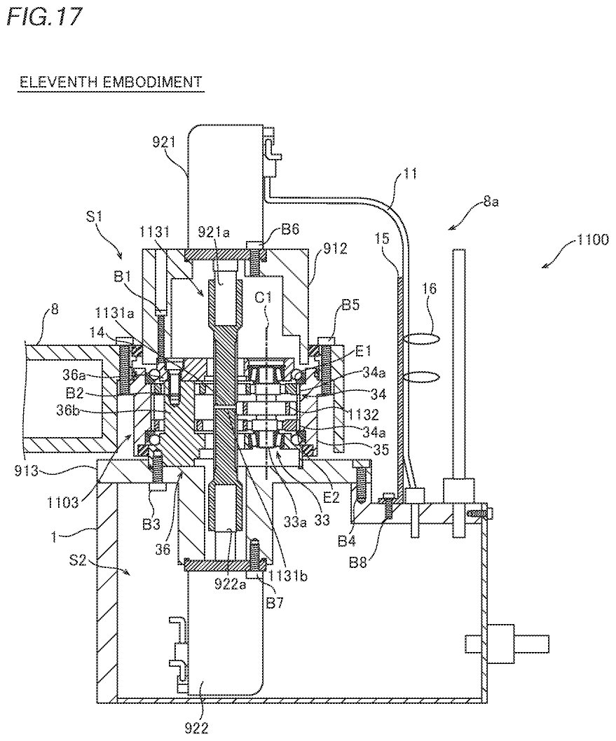

The following description describes a configuration of a SCARA robot 1100 according to an eleventh embodiment with reference to FIG. 17. In the eleventh embodiment, the spur gear 1132 is arranged in a central part of the crankshaft 33a dissimilar to the ninth embodiment. Description of the same configurations in the eleventh embodiment as those of the ninth embodiment is omitted.

The following description describes a configuration of the SCARA robot 1100 according to the eleventh embodiment of the present disclosure with reference to FIG. 17. The SCARA robot 1100 is an example of the “robot” in the claims.

### (Configuration of SCARA Robot)

As shown in FIG. 17, the SCARA robot 1100 is a robot including an arm configured to move in a horizontal direction. The SCARA robot 1100 includes a base 1, a first electric motor 921, a second electric motor 922, a first speed reducer 1103, a third electric motor 4 (see FIG. 1), a second speed reducer 5 (see FIG. 1), a fourth electric motor 6 (see FIG. 1), a fifth electric motor 7 (see FIG. 1), a first arm 8, a second arm 9, and a working unit 10 (see FIG. 1). The first electric motor 921 and the second electric motor 922 are examples of the “electric motor” in the claims.

Here, a first joint 8a is provided in a part connecting the first arm 8 to the base 1. Also, a second joint 9a (see FIG. 1) connecting the first arm 8 to the second arm 9 is provided.

### <Joint Structure Connecting Base to First Arm>

In the SCARA robot 1100 according to the eleventh embodiment, the first electric motor 921 and the second electric motor 922 do not rotate together with the first arm 8 even when the first arm 8 rotates to perform desired operation by using the working unit 10, as shown in FIG. 17. Accordingly, wire sets 11 connected to the first electric motor 921 and the second electric motor 922 do not rotate in response to rotation of the first arm 8, and as a result the wire set 11 can be arranged at a fixed placement position. The following description describes the joint structure (first joint 8a) connecting the base 1 to the first arm 8.

As shown in FIG. 17, the SCARA robot 1100 includes the aforementioned base 1, the aforementioned first electric motor 921, the aforementioned second electric motor 922, the aforementioned first speed reducer 1103, the aforementioned first arm 8, the wire set 11, a first electric-motor holder 912, a second electric-motor holder 913, an oil seal 14, a stay 15, and clamps 16.

The first speed reducer 1103 is an eccentric oscillating speed reducer. In particular, the first speed reducer 1103 is an RV speed reducer. The first speed reducer 1103 is provided to the first joint 8a. The first speed reducer 1103 includes an input part 1131, a spur gear 1132, an eccentric rotating part 33, an external gear part 34, an output part 35, and a carrier 36.

The input part 1131 includes a first input gear 1131a connected to a shaft 921a of the first electric motor 921, and a second input gear 1131b connected to a shaft 922a of the second electric motor 922. The first input gear 1131a is configured to be rotated by a driving force of the first electric motor 921. The second input gear 1131b is configured to be rotated by a driving force of the second electric motor 922.

Each of the plurality of spur gears 1132 is arranged between an end E1 of the external gear part 34 opposite to the base 1 side and an end E2 of the external gear part 34 on the base 1 side in the extension direction of the crankshaft 33a. Specifically, each of the plurality of spur gears 1132 is arranged in a central part of the crankshaft 33a in the extension direction of the crankshaft 33a.

The spur gear 1132 meshes with both the first input gear 1131a and the second input gear 1131b. The other configuration of the eleventh embodiment is similar to the configuration of the aforementioned ninth embodiment.

### (Advantages of Eleventh Embodiment)

In the eleventh embodiment, similar to the aforementioned ninth embodiment, the first speed reducer 1103 is provided to the first joint 8a. Here, the carrier 36 of the first speed reducer 1103 is attached to the base 1 to be prevented from rotating in response to rotation of the first arm 8 rotated by the output part 35 of the first speed reducer 1103. The first electric motor 2 is attached to the carrier 36. Accordingly, it is possible to simplify a configuration of the SCARA robot 1100 by using the general-purpose wire set 11, which is more widely used.

Also, in the eleventh embodiment, as discussed above, the first speed reducer 1103 includes the external gear part 34 having external teeth 134 that mesh with the output part 35 and configured to decelerate and transmit the rotation of the crankshaft 33a to the output part 35 by oscillating in response to the rotation of the crankshaft 33a with the external gear part being attached to the carrier 36 to be able to oscillate. Each of the plurality of spur gears 1132 is arranged between an end E1 of the external gear part 34 opposite to the base 1 side and an end E2 of the external gear part 34 on the base 1 side in the extension direction of the crankshaft 33a. Accordingly, because an interval between the first electric motor 921 and the first input gear 1131a can be equal to an interval between the second electric motor 922 and the second input gear 1131b, it is possible to reduce a difference between a mass of a shaft extending from the first electric motor 921 to the first input gear 1131a and a mass of a shaft extending from the second electric motor 922 to the second input gear 1131b. Because difference between inertia (moment of inertia) generated when the first input gear 1131a is rotated and inertia (moment of inertia) generated when the second input gear 1131b is rotated can be reduced, it is possible to easily control the first electric motor 921 and the second electric motor 922 in synchronization with each other. The other advantages of the eleventh embodiment are similar to the advantages of the aforementioned ninth embodiment.

### Twelfth Embodiment

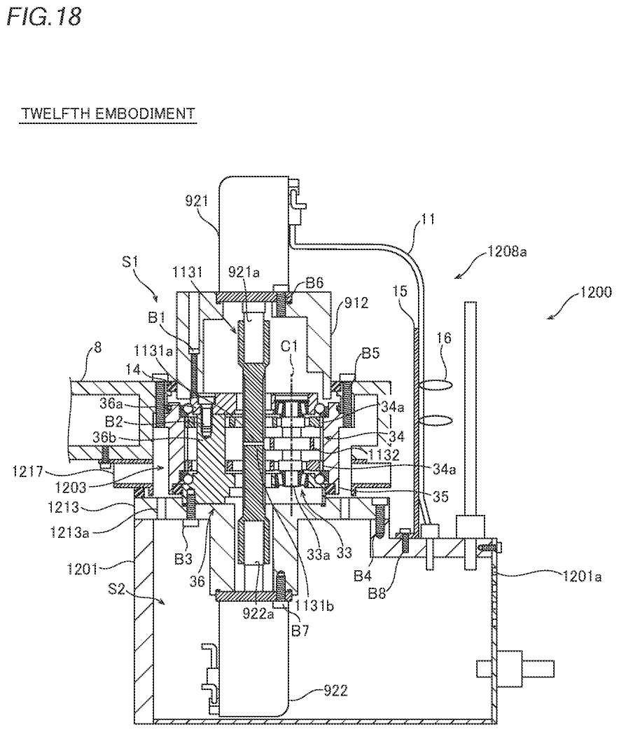

The following description describes a configuration of a SCARA robot 1200 according to a twelfth embodiment with reference to FIG. 18. In the twelfth embodiment, dissimilar to the eleventh embodiment, the SCARA robot 1200 includes an impeller 1217. Description of the same configurations in the twelfth embodiment as those of the eleventh embodiment is omitted.

The following description describes a configuration of the SCARA robot 1200 according to the twelfth embodiment of the present disclosure with reference to FIG. 18. The SCARA robot 1200 is an example of the “robot” in the claims.

### (Configuration of SCARA Robot)

As shown in FIG. 18, the SCARA robot 1200 is a robot including an arm configured to move in a horizontal direction. The SCARA robot 1200 includes a base 1201, a first electric motor 921, a second electric motor 922, a first speed reducer 1203, a third electric motor 4 (see FIG. 1), a second speed reducer 5 (see FIG. 1), a fourth electric motor 6 (see FIG. 1), a fifth electric motor 7 (see FIG. 1), a first arm 8, a second arm 9, and a working unit 10 (see FIG. 1). The first electric motor 921 and the second electric motor 922 are examples of the “electric motor” in the claims.

Here, a first joint 1208a is provided in a part connecting the first arm 8 to the base 1201. Also, a second joint 9a (see FIG. 1) connecting the first arm 8 to the second arm 9 is provided.

### <Joint Structure Connecting Base to First Arm>

In the SCARA robot 1200 according to the twelfth embodiment, the first electric motor 921 and the second electric motor 922 do not rotate together with the first arm 8 even when the first arm 8 rotates to perform desired operation by using the working unit 10. Accordingly, wire sets 11 connected to the first electric motor 921 and the second electric motor 922 do not rotate in response to rotation of the first arm 8, and as a result the wire set 11 can be arranged at a fixed placement position. The following description describes the joint structure (first joint 1208a) connecting the base 1201 to the first arm 8.

As shown in FIG. 18, the SCARA robot 1200 includes the aforementioned base 1201, the aforementioned first electric motor 921, the aforementioned second electric motor 922, the aforementioned first speed reducer 1203, the aforementioned first arm 8, the wire set 11, a first electric-motor holder 912, a second electric-motor holder 1213, an oil seal 14, a stay 15, clamps 16 and the impeller 1217.

The base 1201 includes a base-side venting part 1201a configured to provide ventilation between interior space S2 of the base 1201 and exterior space S1 of the base 1201. The base-side venting part 1201a has slits. Alternatively, the base-side venting part 1201a can be a filter.

The second electric-motor holder 1213 includes a holder-side venting part 1213a configured to provide ventilation between interior space S2 of the base 1201 and exterior space S1 of the base 1201. The holder-side venting part 1213a has slits. Alternatively, the holder-side venting part 1213a can be a filter.

The impeller 1217 is attached to the first arm 8 and configured to rotate together with the first arm 8 so as to flow air from the interior space S2 of the base 1201 to the exterior space S1 of the base 1201. The impeller 1217 is a centrifugal impeller. The impeller 1217 is attached to the base 1201 side of the first arm 8. In this configuration, air can flow through the base-side venting part 1201a, the interior space S2 of the base 1201, the holder-side venting part 1213a, and the impeller 1217 to the exterior space S1 of the base 1201 in this order when the impeller 1217 rotates. Accordingly, the second electric motor 922, which is fixed to the second carrier part 36b, can be cooled with the second electric motor being arranged in the interior space S2 of the base 1201. The other configuration of the twelfth embodiment is similar to the configuration of the aforementioned eleventh embodiment.

### (Advantages of Twelfth Embodiment)

In the twelfth embodiment, similar to the aforementioned eleventh embodiment, the first speed reducer 1203 is provided to the first joint 1208a. Here, the carrier 36 of the first speed reducer 1203 is attached to the base 1201 to be prevented from rotating in response to rotation of the first arm 8 rotated by the output part 35 of the first speed reducer 1203. The first electric motor 2 is attached to the carrier 36. Accordingly, it is possible to simplify a configuration of the SCARA robot 1200 by using the general-purpose wire set 11, which is more widely used.

In the twelfth embodiment, as discussed above, the second electric motor 922 is fixed to the second carrier part 36b with the second electric motor being arranged in the interior space S2 of the base 1201. The SCARA robot 1200 includes the impeller 1217 attached to the first arm 8 and configured to rotate together with the first arm 8 so as to flow air from the interior space S2 of the base 1201 to the exterior space S1 of the base 1201. Accordingly, because the second electric motor 922 arranged in the interior space S2 of the base 1201 can be cooled by the impeller 1217, it is possible to efficiently cool the second electric motor 922 arranged in the interior space S2 of the base 1201. As a result, because thermal characteristics of both the first electric motor 921 and the second electric motor 922 can be substantially equal to each other, it is possible to easily control the first electric motor 921 and the second electric motor 922 in synchronization with each other. The other advantages of the twelfth embodiment are similar to the advantages of the aforementioned eleventh embodiment.

### Thirteenth Embodiment

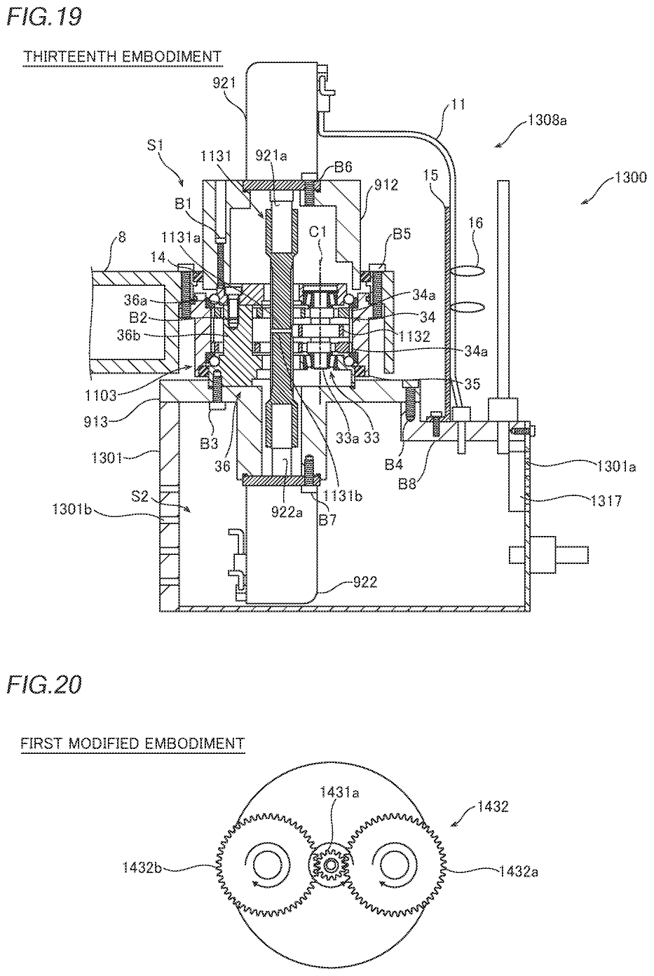

The following description describes a configuration of a SCARA robot 1300 according to a thirteenth embodiment with reference to FIG. 19. In the thirteenth embodiment, dissimilar to the eleventh embodiment, the SCARA robot 1300 includes an electric fan 1317. Description of the same configurations in the thirteenth embodiment as those of the eleventh embodiment is omitted.

The following description describes a configuration of the SCARA robot 1300 according to the thirteenth embodiment of the present disclosure with reference to FIG. 19. The SCARA robot 1300 is an example of the “robot” in the claims.

### (Configuration of SCARA Robot)

As shown in FIG. 19, the SCARA robot 1300 is a robot including an arm configured to move in a horizontal direction. The SCARA robot 1300 includes a base 1301, a first electric motor 921, a second electric motor 922, a first speed reducer 1103, a third electric motor 4 (see FIG. 1), a second speed reducer 5 (see FIG. 1), a fourth electric motor 6 (see FIG. 1), a fifth electric motor 7 (see FIG. 1), a first arm 8, a second arm 9, and a working unit 10 (see FIG. 1). The first electric motor 921 and the second electric motor 922 are examples of the “electric motor” in the claims.

Here, a first joint 1308a is provided in a part connecting the first arm 8 to the base 1301. Also, a second joint 9a (see FIG. 1) connecting the first arm 8 to the second arm 9 is provided.

### <Joint Structure Connecting Base to First Arm>

In the SCARA robot 1300 according to the thirteenth embodiment, the first electric motor 921 and the second electric motor 922 do not rotate together with the first arm 8 even when the first arm 8 rotates to perform desired operation by using the working unit 10, as shown in FIG. 19. Accordingly, wire sets 11 connected to the first electric motor 921 and the second electric motor 922 do not rotate in response to rotation of the first arm 8, and as a result the wire set 11 can be arranged at a fixed placement position. The following description describes the joint structure (first joint 1308a) connecting the base 1301 to the first arm 8.

As shown in FIG. 19, the SCARA robot 1300 includes the aforementioned base 1301, the aforementioned first electric motor 921, the aforementioned second electric motor 922, the aforementioned first speed reducer 1103, the aforementioned first arm 8, the wire set 11, a first electric-motor holder 912, a second electric-motor holder 913, an oil seal 14, a stay 15, clamps 16, and an electric fan 1317.

The base 1301 includes a first base-side venting part 1301a configured to provide ventilation between interior space S2 of the base 1301 and exterior space S1 of the base 1301. The first base-side venting part 1301a has slits. Alternatively, the first base-side venting part 1301a can be a filter. The base 1301 includes a second base-side venting part 1301b configured to provide ventilation between interior space S2 of the base 1301 and exterior space S1 of the base 1301. The second base-side venting part 1301b has slits. Alternatively, the second base-side venting part 1301b can be a filter.

The electric fan 1317 is attached to the base 1301 and is configured to flow air from the interior space S2 of the base 1301 to the exterior space S1 of the base 1301. The electric fan 1317 is attached to a part of an interior surface of the base 1301 where the first base-side venting part 1301a is formed. In this configuration, air can flow through the first base-side venting part 1301a, the interior space S2 of the base 1301, and the second base-side venting part 1301b, to the exterior space S1 of the base 1301 in this order when the electric fan 1317 is driven. Accordingly, the second electric motor 922, which is fixed to the second carrier part 36b, can be cooled with the second electric motor being arranged in the interior space S2 of the base 1301. The other configuration of the thirteenth embodiment is similar to the configuration of the aforementioned eleventh embodiment.

### (Advantages of Thirteenth Embodiment)

In the thirteenth embodiment, similar to the aforementioned eleventh embodiment, the first speed reducer 1103 is provided to the first joint 1308a. Here, the carrier 36 of the first speed reducer 1103 is attached to the base 1 to be prevented from rotating in response to rotation of the first arm 8 rotated by the output part 35 of the first speed reducer 1103. The first electric motor 2 is attached to the carrier 36. Accordingly, it is possible to simplify a configuration of the SCARA robot 1300 by using the general-purpose wire set 11, which is more widely used.

In the thirteenth embodiment, as discussed above, the second electric motor 922 is fixed to the second carrier part 36b with the second electric motor being arranged in the interior space S2 of the base 1301. The SCARA robot 1300 includes the electric fan 1317 attached to the base 1301 and configured to flow air from the interior space S2 of the base 1301 to the exterior space S1 of the base 1301. Accordingly, because the second electric motor 922 arranged in the interior space S2 of the base 1301 can be cooled by the electric fan 1317, it is possible to efficiently cool the second electric motor 922 arranged in the interior space S2 of the base 1301. The other advantages of the thirteenth embodiment are similar to the advantages of the aforementioned eleventh embodiment.

### Modified Embodiments

Note that the embodiment disclosed this time must be considered as illustrative in all points and not restrictive. The scope of the present disclosure is not shown by the above description of the embodiments but by the scope of claims for patent, and all modifications (modified embodiments) within the meaning and scope equivalent to the scope of claims for patent are further included.

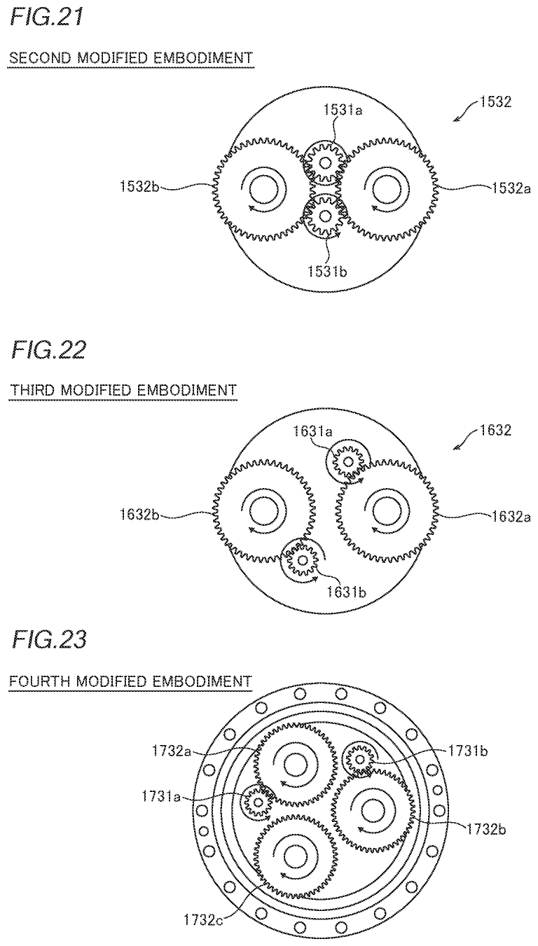

While the example in which the plurality of spur gears 32 includes the first spur gear 32a, the second spur gear 32b, and the third spur gear 32c has been shown in the aforementioned ninth to thirteenth embodiments, the present disclosure is not limited to this. In the present disclosure, alternatively, the plurality of spur gears 1432 can include a first spur gear 1432a and a second spur gear 1432b as shown in a first modified embodiment of in FIG. 20. In this case, the first spur gear 1432a and the second spur gear 1432b are connected to the first electric motor (not shown) through the first input gear 1431a, and to the second electric motor (not shown) through the second input gear (not shown). Among the aforementioned ninth to thirteenth embodiments, only in the seventh and eighth embodiments, the plurality of spur gears 1532 can include a first spur gear 1532a and a second spur gear 1532b as shown in a second modified embodiment of in FIG. 21. In this case, the first spur gear 1532a is connected to the first electric motor (not shown) through a first input gear 1531a, and to the second electric motor (not shown) through a second input gear 1531b. The second spur gear 1532b is connected to the first electric motor (not shown) through the first input gear 1531a, and to the second electric motor (not shown) through the second input gear 1531b. In the aforementioned ninth to thirteenth embodiments, the plurality of spur gears 1632 can include a first spur gear 1632a and a second spur gear 1632b as shown in a third modified embodiment of in FIG. 22. In this case, the first spur gear 1632a is connected to the first electric motor (not shown) through a first input gear 1631a. The second spur gear 1632b is connected to the second electric motor (not shown) through the second input gear 731b.

While the example in which the first spur gear 32a and the second spur gear 32b are connected to the first electric motor 721 (821) through the first input gear 731a (831a), and the second spur gear 32b and the third spur gear 32c are connected to the second electric motor 722 (822) through the second input gear 731b (831b) has been shown in the aforementioned seventh and eighth embodiments, the present disclosure is not limited to this. In the present disclosure, alternatively, as shown in a fourth modified embodiment of FIG. 23, the first spur gear 1732a can be connected to the first electric motor (not shown) through a first input gear 1731a, and the second spur gear 1732b can be connected to the second electric motor (not shown) through the second input gear 1731b.

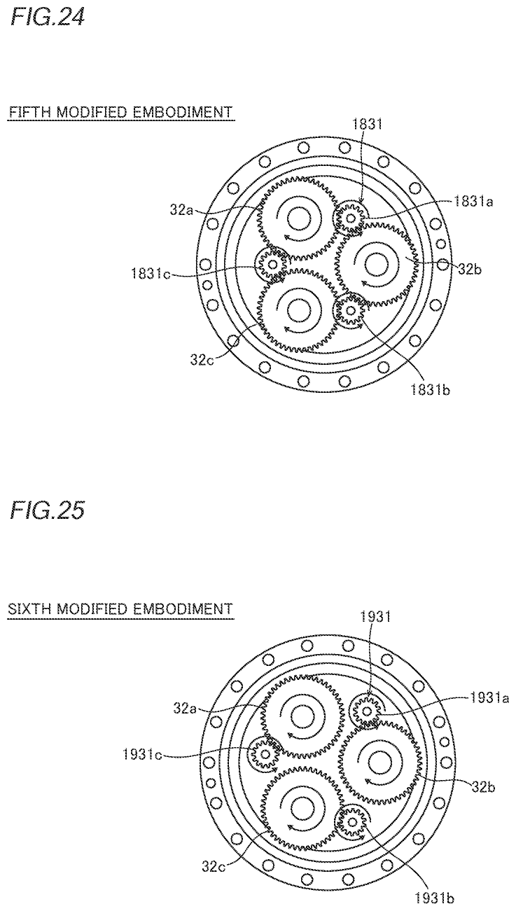

While the example in which the input part 731 (831) includes the first input gear 731a (831a) and the second input gear 731b (831b) has been shown in the aforementioned seventh and eighth embodiments, the present disclosure is not limited to this. In the present disclosure, alternatively, as shown in a fifth modified embodiment of FIG. 24, the input part 1831 can include a first input gear 1831a, a second input gear 1831b, a third input gear 1831c. The third input gear 1831c is connected to a shaft (not shown) of a third electric motor (not shown). The first spur gear 32a is connected to the first electric motor (not shown) through the first input gear 1831a, and to the third electric motor (not shown) through the third input gear 1831c. The second spur gear 32b is connected to the first electric motor (not shown) through the first input gear 1831a, and to the second electric motor (not shown) through the second input gear 1831b. The third spur gear 32c is connected to the second electric motor (not shown) through the second input gear 1831b, and to the third electric motor (not shown) through the third input gear 1831c.

Alternatively, as shown in a sixth modified embodiment of FIG. 25, the input part 1931 can include a first input gear 1931a, a second input gear 1931b, a third input gear 1931c. The third input gear 1931c is connected to a shaft (not shown) of a third electric motor (not shown). The first spur gear 32a is connected to the third electric motor (not shown) through the third input gear 1931c. The second spur gear 32b is connected to the first electric motor (not shown) through the first input gear 1931a. The third spur gear 32c is connected to the second electric motor (not shown) through the second input gear 1931b.

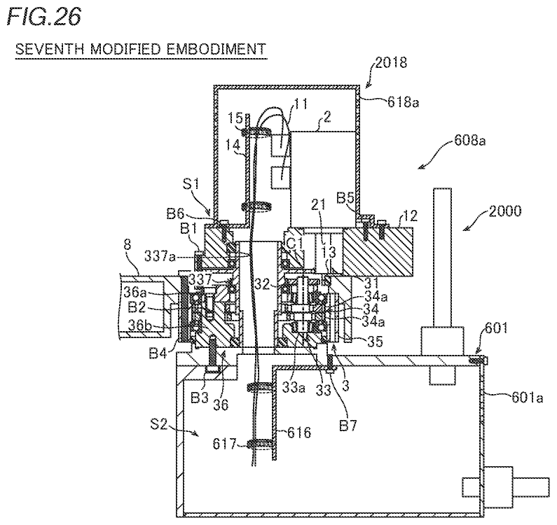

While the example in which the first electric motor 2 and the electric-motor cover 618 are connected to each other through the heat conductor 619 has been shown in the aforementioned sixth embodiment, the present disclosure is not limited to this. In the present disclosure, alternatively, as shown in a seventh modified embodiment of FIG. 26, the first electric motor 2 and the electric-motor cover 2018 can be directly connected to each other.

While the example in which the first electric motor 2 is arranged on an upper side of the base 1 has been shown in the aforementioned first embodiment, the aforementioned third to sixth embodiments, and the aforementioned eighth embodiment, the present disclosure is not limited to this. In the present disclosure, alternatively, the first electric motor can be arranged on a lower side of the base.

While the example in which the robot as an example of the “robot” in the claims is the SCARA robot 100 (200, 300, 400, 500, 600, 700, 800, 900, 1000, 1100, 1200, 1300) has been shown in the aforementioned first to thirteenth embodiments, but the present disclosure is not limited to this. In the present disclosure, alternatively, the robot can be a vertical multi-joint robot.

While the example in which the first speed reducer 3 (eccentric oscillating speed reducer) is an RV speed reducer has been shown in the aforementioned first to sixth embodiments, the present disclosure is not limited to this. In the present disclosure, alternatively, the eccentric oscillating speed reducer may be a Cyclo speed reducer (registered trademark).

What is claimed is:

1. A robot comprising:
a base;
a first arm relatively rotatably attached to the base;
a second arm relatively rotatably attached to the first arm;
a first joint connecting the first arm and the base to each other;
a second joint connecting the first arm and the second arm to each other;
an electric motor; and
an eccentric oscillating speed reducer including an input part configured to be rotated by a driving force of the electric motor, an eccentric rotating part configured to receive rotation of the input part that is decelerated and transmitted to the eccentric rotating part, an output part configured to receive rotation of the eccentric rotating part that is decelerated and transmitted to the output part, and a carrier inside the output part, wherein
the carrier of the eccentric oscillating speed reducer is attached to the base to be prevented from rotating in response to rotation of the first arm rotated by the output part of the eccentric oscillating speed reducer in a case in which the eccentric oscillating speed reducer is provided to the first joint, and is attached to the first arm to be prevented from rotating in response to rotation of the second arm rotated by the output part of the eccentric oscillating speed reducer in a case in which the eccentric oscillating speed reducer is provided to the second joint; and
the electric motor is attached to the carrier.

2. The robot according to claim 1 further comprising:
an electric-motor holder attached to the carrier with the electric-motor holder being holding the electric motor.

3. The robot according to claim 2, wherein the carrier is attached to the base to be prevented from rotating in response to rotation of the first arm; and
the electric motor is in exterior space of the base and fixed to the carrier with the electric-motor holder.

4. The robot according to claim 3, further comprising:
an oil seal between the electric-motor holder and the first arm.

5. The robot according to claim 3 wherein
one electric motor is configured as the electric motor;
the carrier includes a first carrier part on a side opposite to the base side in an extension direction of a rotation axis of the eccentric rotating part, and a second carrier part connected to the first carrier part and being on the base side in the extension direction of the rotation axis of the eccentric rotating part;
the second carrier part is attached to the base; and
the electric motor is attached to the first carrier part.

6. The robot according to claim 5, wherein the electric motor is at an offset position offset from a center of the first carrier part in a radial direction orthogonal to the extension direction of the rotation axis of the eccentric rotating part.

7. The robot according to claim 6, wherein
the eccentric oscillating speed reducer includes a hollow transmission shaft having a through hole extending in the extension direction of the rotation axis of the eccentric rotating part and connected to the input part to transmit the driving force from the electric motor to the eccentric rotating part; and
the robot further comprises a wire set connected to the electric motor with the wire set passing through the through hole.

8. The robot according to claim 7, wherein
the base includes a base-side venting part configured to provide ventilation between interior space of the base and the exterior space of the base; and
the robot further comprises a shaft cover covering the electric motor side of the through hole of the transmission shaft in the extension direction of the rotation axis of the eccentric rotating part and having a speed-reducer-side venting part configured to provide ventilation between the interior space of the base and the exterior space of the base through the through hole.

9. The robot according to claim 2, wherein the electric-motor holder includes a protruding fin formed an exterior surface of the electric-motor holder.

10. The robot according to claim 7, wherein
the base includes a base-side venting part configured to provide ventilation between interior space of the base and the exterior space of the base; and
the robot further comprises an electric-motor cover covering the electric motor and having an electric-motor side venting part configured to provide ventilation between the interior space of the base and the exterior space of the base through the through hole.

11. The robot according to claim 10, wherein the electric motor and the electric-motor cover are directly connected to each other, or are connected to each other with a heat conductor.

12. The robot according to claim 2 wherein
a plurality of electric motors are configured to rotate in synchronization with each other as the electric motor;
the eccentric rotating part includes a plurality of crankshafts; and
the plurality of crankshafts are configured to be rotated by driving forces of the plurality of electric motors.

13. The robot according to claim 12, wherein
the plurality of electric motors includes a first electric motor and a second electric motor;
the carrier includes
a first carrier part on a side opposite to the base or first arm side in an extension direction of a rotation axis of the crankshaft, and
a second carrier part connected to the first carrier part and on the base or first arm side in the extension direction of the rotation axis of the crankshaft;
the first electric motor is attached to at least one of the first carrier part and the second carrier part; and
the second electric motor is attached to at least one of the first carrier part and the second carrier part.

14. The robot according to claim 13, wherein
the second carrier part is attached to the base or the first arm; and
both the first electric motor and the second electric motor are attached to the second carrier part with the first electric motor and the second electric motor being in interior space of the base or the first arm.

15. The robot according to claim 13, wherein
the second carrier part is attached to the base or the first arm; and
both the first electric motor and the second electric motor are attached to the first carrier part with the first electric motor and the second electric motor being in exterior space of the base or the first arm.

16. The robot according to claim 13, wherein
the second carrier part is attached to the base or the first arm;
the first electric motor is attached to the first carrier part; and
the second electric motor is attached to the base or the first arm, to which the second carrier part is attached, with the second electric motor being in interior space of the base or the first arm.

17. The robot according to claim 16, wherein
the input part includes
a first input gear connected to the first electric motor, and
a second input gear connected to the second electric motor; and
the eccentric oscillating speed reducer includes a plurality of spur gears configured to transmit a driving force of the first input gear and a driving force of the second input gear to the plurality of crankshafts.

18. The robot according to claim 17, wherein
the first input gear and the second input gear mesh with the plurality of spur gears that are common to the first input gear and the second input gear; and
the plurality of spur gears that are common to the first input gear and the second input gear are on the base or first arm side of each of the plurality of crankshafts with the first input gear meshing with the first carrier side of each of the plurality spur gears and the second input gear meshing with the second carrier side of each of the plurality of spur gears.

19. The robot according to claim 17, wherein
the plurality of spur gears include
a first spur gear on a side of each of the plurality of crankshafts opposite to the base or first arm side and connected to the first input gear, and
a second spur gear on the base or first arm side of each of the plurality of crankshafts and connected to the second input gear.

20. The robot according to claim 19, wherein an interval between the first electric motor and the first input gear is substantially equal to an interval between the second electric motor and the second input gear in an extension direction of the crankshaft.

21. The robot according to claim 17, wherein
the eccentric oscillating speed reducer further includes an external gear part having external teeth that mesh with the output part and configured to decelerate and transmit the rotation of the crankshaft to the output part by oscillating in response to the rotation of the crankshaft with the external gear part being attached to the carrier to be able to oscillate; and
each of the plurality of spur gears is between an end of the external gear part opposite to the base or first arm side and an end of the external gear part on the base or first arm side in the extension direction of the crankshaft.

22. The robot according to claim 13, wherein
at least one of the first electric motor and the second electric motor is fixed to the second carrier part with the at least one of the first electric motor and the second electric motor being in interior space of the base; and
the robot further comprises an impeller attached to the first arm and configured to rotate together with the first arm so as to flow air from the interior space of the base to exterior space of the base.

23. The robot according to claim 13, wherein
at least one of the first electric motor and the second electric motor is fixed to the second carrier part with the at least one of the first electric motor and the second electric motor being in interior space of the base; and
the robot further comprises an electric fan attached to the base and configured to flow air from the interior space of the base to exterior space of the base.

24. A robot comprising:
a base;
a first arm relatively rotatably attached to the base;
a second arm relatively rotatably attached to the first arm;
a first joint connecting the first arm and the base to each other;
a second joint connecting the first arm and the second arm to each other;
an electric motor; and
an eccentric oscillating speed reducer including an input part configured to be rotated by a driving force of the electric motor, an eccentric rotating part configured to receive rotation of the input part that is decelerated and transmitted to the eccentric rotating part, an output part configured to receive rotation of the eccentric rotating part that is decelerated and transmitted to the output part, and a carrier inside the output part, wherein
the carrier of the eccentric oscillating speed reducer has at least one of a configuration in which the carrier is attached to the base to be prevented from rotating in response to rotation of the first arm rotated by the output part of the eccentric oscillating speed reducer in a case in which the eccentric oscillating speed reducer is provided to the first joint, and a configuration in which the carrier is attached to the first arm to be prevented from rotating in response to rotation of the second arm rotated by the output part of the eccentric oscillating speed reducer in a case in which the eccentric oscillating speed reducer is provided to the second joint,
the electric motor is attached to the carrier,
the carrier includes
a first carrier part on a side opposite to the base or first arm side in an extension direction of a rotation axis of the eccentric rotating part, and
a second carrier part connected to the first carrier part and on the base or first arm side in the extension direction of the rotation axis of the eccentric rotating part,
the second carrier part is attached to the base or the first arm, and
the electric motor is attached to the first carrier part or the second carrier part.

25. A robot comprising:
a base;
a first arm relatively rotatably attached to the base;
a second arm relatively rotatably attached to the first arm;
a first joint connecting the first arm and the base to each other;
a second joint connecting the first arm and the second arm to each other;
an electric motor; and
an eccentric oscillating speed reducer including an input part configured to be rotated by a driving force of the electric motor, an eccentric rotating part configured to receive rotation of the input part that is decelerated and transmitted to the eccentric rotating part, an output part configured to receive rotation of the eccentric rotating part that is decelerated and transmitted to the output part, and a carrier inside the output part, wherein
the carrier of the eccentric oscillating speed reducer has at least one of a configuration in which the carrier is attached to the base to be prevented from rotating in response to rotation of the first arm rotated by the output part of the eccentric oscillating speed reducer in a case in which the eccentric oscillating speed reducer is provided to the first joint, and a configuration in which the carrier is attached to the first arm to be prevented from rotating in response to rotation of the second arm rotated by the output part of the eccentric oscillating speed reducer in a case in which the eccentric oscillating speed reducer is provided to the second joint,
the electric motor is attached to the carrier, and the robot further comprises
an electric-motor holder that is attached to the carrier with the electric-motor holder being holding the electric motor, and
an oil seal that is between the electric-motor holder and the first arm in a case in which the eccentric oscillating speed reducer is provided to the first joint, or between the electric-motor holder and the second arm in a case in which the eccentric oscillating speed reducer is provided to the second joint.
